(19) United States
(12) Patent Application Publication
(10) Pub. No.: US 2010/0131663 A1
(43) Pub. Date: May 27, 2010

(54) METHOD FOR PRE-CONFIGURATION OF IP ADDRESS IN MOBILE COMMUNICATION SYSTEM

(76) Inventors: Jin Lee, Gyeonggi-do (KR); Yong Ho Kim, Gyeonggi-do (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/374,295

(22) PCT Filed: Jul. 16, 2007
(86) PCT No.: PCT/KR2007/003450

§ 371 Date: Nov. 6, 2009

Related U.S. Application Data
(60) Provisional application No. 60/807,692, filed on Jul. 18, 2006.

(30) Foreign Application Priority Data
Jan. 16, 2007 (KR) 10-2007-0004952

(51) Int. Cl. G06F 15/16; H04W 36/00

(52) U.S. Cl. 709/228

(57) ABSTRACT

A handover method between heterogeneous networks is disclosed. A method for pre-configuration of an IP address allows a mobile terminal to perform a handover between heterogeneous networks. Methods for relaying messages for pre-configuration of IP address and a method for relaying messages for performing MIH based on pre-configuration of IP address are also disclosed.

### TECHNICAL FIELD

The present invention relates to a handover between heterogeneous networks, and more particularly to a method for pre-configuration of an IP address to allow a mobile node (MN) (also called a mobile terminal or mobile node (MN)) to effectively perform a handover between heterogeneous networks.

### BACKGROUND ART

Conventionally, in the case of using MIPv4, MIPv6, and FMIPv6, a handover of a second layer (L2) and a handover of a third layer (L3) are performed independent of each other. In other words, the L2 handover is performed, and then the L3 handover is performed, such that a delay occurs.

The network must recognize the L2 handover, and must directly transmit a L3-handover message to a destination. However, the L3 layer of the network is unable to recognize the above-mentioned situation, such that the conventional system must transmit unnecessary messages.

And, in case of a handover between homogeneous networks, if data communication between MIH (Media Independent Handover) entities is supported, IP address can be used without any change when re-configuration of the IP address.

But, in the case of a handover between heterogeneous networks, which should changes IP address in a wireless communication system, the MN (mobile node) receives IP address configuration—associated information for configuration of the IP address to be used after performing the handover, such that it encounters a time delay after the handover.

### DISCLOSURE

### Technical Problem

Accordingly, the present invention is directed to a method for pre-configuration of an IP address in a mobile communication system that substantially obviates one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solution

To achieve these objects and other advantages and in accordance with the purpose of the invention, as embodied and broadly described herein, a method for pre-configuration of IP (internet Protocol) address by a mobile node (MN) is provided. The method comprises transmitting a request message for the pre-configuration of IP address, and receiving a response message to the request message. The response message comprises information indicating which IP configuration method in IP configuration methods information is supported at one or more point of attachment (PoA). And, preferably if the information indicates supporting of IPv4 dynamic configuration (DHCPv4), mobile IPv4 without foreign agent (Co-located CoA) or IPv6 stateful address configuration (DHCPv6), the response message further comprises dynamic host configuration protocol (DHCP) server address type-length value (TLV), which allows the MN the prefongifuration of the IP address. Or, preferably, if the information indicates supporting of mobile IPv4 with foreign agent (FA-CoA) or IPv6 stateless address configuration, the response message further comprises foreign agent or access router (FA/AR) address type-length value (TLV), which allows the MN the prefongifuration of the IP address.

And, the method further comprises performing the pre-configuration of the IP address based on the received response message.

In another embodiment of this invention, a method for pre-configuration of IP (internet Protocol) address by a mobile node (MN) is provided. The method comprises transmitting to a serving point of service (PoS) a request message for query if a current IP configuration method of ongoing data session can be supported in one or more candidate networks; receiving a response message to the request message, the response message comprises information for IP address of the one or more candidate networks and IP configuration methods for each of the candidate networks; and performing the pre-configuration of the IP address of a target network based on the information from the received message, the target network is decided based on the information from the received message.

Preferably, this request message may comprise information for the current IP configuration method of the ongoing data session and a current link IP address. And, the information for the current IP configuration method may be information indicating which IP configuration method in IP configuration methods information is supported.

More preferably, if the information indicates supporting of IPv4 dynamic configuration (DHCPv4), mobile IPv4 without foreign agent (Co-located CoA) or IPv6 stateful address configuration (DHCPv6), one or more of the request message and the response message to the request message further comprise dynamic host configuration protocol (DHCP) server address type-length value (TLV). And/or, if the information indicates supporting of mobile IPv4 with foreign agent (FA-CoA) or IPv6 stateless address configuration, one or more of the request message and the response message to the request message further comprise foreign agent or access router (FA/AR) address type-length value (TLV).

In still another embodiment of this invention, a method for relaying messages for pre-configuration of IP (internet Protocol) address by a serving point of service (PoS) is provided. The method comprises receiving from mobile node (MN) a first request message query if a current IP configuration method of ongoing data session can be supported in one or more candidate networks; transmitting to media independent handover function (MIHF) of the candidate networks a second request message comprising information for the current IP configuration method; receiving from the one or more candidate networks a first response message comprising information for IP addresses of the candidate networks and IP configuration methods for each of the candidate networks; and transmitting to the MN a second response message to the first request message comprising information regarding the first response message.

Preferably, the first request message may comprise information for the current IP configuration method of the ongoing data session and a current link IP address. And, the information for the current IP configuration method mat be information indicating which IP configuration method in IP configuration methods information is supported.

More preferably, if the information indicates supporting of IPv4 dynamic configuration (DHCPv4), mobile IPv4 without foreign agent (Co-located CoA) or IPv6 stateful address configuration (DHCPv6), one or more of the first request message, the second request message, the first response message and the second response message may further comprise dynamic host configuration protocol (DHCP) server address type-length value (TLV). And, or if the information indicates supporting of mobile IPv4 with foreign agent (FA-CoA) or IPv6 stateless address configuration, one or more of the first request message, the second request message, the first response message and the second response message may further comprise foreign agent or access router (FA/AR) address type-length value (TLV).

In still another embodiment of this invention, a method for performing media independent handover (MIH) based on a pre-configuration of IP (internet Protocol) address by a mobile node (MN) is provided. The method comprises transmitting to a serving point of service (PoS) a first request message for query if a current IP configuration method of ongoing data session can be supported in one or more candidate networks; receiving a first response message to the first request message, the first response message comprises information for IP address of the one or more candidate networks and IP configuration methods for each of the candidate networks; and transmitting to the serving PoS a second request message for informing the serving PoS to commit handover to a target network, the target network is decided based on the information from the received message.

Preferably, the method may further comprises receiving a second response message to the second request message for indicating the MN of status of operation of performing handover to the target network.

And, preferably, the first request message may comprise information for the current IP configuration method of the ongoing data session and a current link IP address. And, the information for the current IP configuration method may be information indicating which IP configuration method in IP configuration methods information is supported.

And, more preferably, if the information indicates supporting of IPv4 dynamic configuration (DHCPv4), mobile IPv4 without foreign agent (Co-located CoA) or IPv6 stateful address configuration (DHCPv6), one or more of the first request message and the first response message may further comprise dynamic host configuration protocol (DHCP) server address type-length value (TLV). And/or, if the information indicates supporting of mobile IPv4 with foreign agent (FA-CoA) or IPv6 stateless address configuration, one or more of the first request message and the first response message may further comprise foreign agent or access router (FA/AR) address type-length value (TLV).

In still another embodiment of this invention, a method for relaying messages for performing media independent handover (MIH) based on pre-configuration of IP (internet Protocol) address by a serving point of service (PoS) is provided. The method comprises receiving from mobile node (MN) a first request message query if a current

IP configuration method of ongoing data session can be supported in one or more candidate networks; transmitting to media independent handover function (MIHF) of the candidate networks a second request message comprising information for the current IP configuration method; receiving from the one or more candidate networks a first response message comprising information for IP addresses of the candidate networks and IP configuration methods for each of the candidate networks; transmitting to the MN a second response message to the first request message comprising information regarding the first response message; receiving from the MN a third request message for informing the serving PoS to commit handover to a target network, the target network is decided by the MN based on the information from the second response message; and transmitting to the target network a third response message for indicating the target network of a fact that the MN is about to move to the target network.

Preferably, the first request message may comprise information for the current IP configuration method of the ongoing data session and a current link IP address. And, the information for the current IP configuration method may be information indicating which IP configuration method in IP configuration methods information is supported.

More preferably, if the information indicates supporting of IPv4 dynamic configuration (DHCPv4), mobile IPv4 without foreign agent (Co-located CoA) or IPv6 stateful address configuration (DHCPv6), one or more of the first request message, the second request message, the first response message and the second response message may further comprise dynamic host configuration protocol (DHCP) server address type-length value (TLV). And/or, if the information indicates supporting of mobile IPv4 with foreign agent (FA-CoA) or IPv6 stateless address configuration, one or more of the first request message, the second request message, the first response message and the second response message may further comprise foreign agent or access router (FA/AR) address type-length value (TLV).

It is to be understood that both the foregoing general description and the following detailed description of the present invention are exemplary and explanatory and are intended to provide further explanation of the invention as claimed.

### Advantageous Effects

The method for pre-configuration of an IP address in a mobile communication system has the following effects.

The method according to one embodiment of the present invention can make the MN to receive IP address configuration—associated information prior to performing the handover, when a handover between heterogeneous networks, which causes the IP address change in a wireless communication system, occurs. So, this invention make it possible to performing pre-configuration of IP address in MIH between heterogeneous networks.

Also, the method according to another embodiment of the present invention can make the point of service (PoS), such as serving BS, to relay IP address configuration—associated information between the MN and one or more candidate networks for pre-configuration of the IP address, such that a time delay required for the IP configuration process after the handover can be shortened.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a structural diagram illustrating protocol layers of a multimode mobile node (MN);

FIG. 2 is a conceptual diagram illustrating functional entities of a mobile node (MN) equipped with a MIH function, functional entities of a network, and transmission protocols;

FIG. 3 is a conceptual diagram illustrating a trigger model;

FIG. 4 is an exemplary diagram illustrating triggers generated until a mobile node (MN) establishes a new link due to a quality deterioration of a link currently connected to the mobile node (MN);

FIG. 5 is a conceptual diagram illustrating basic operations of a mobile IPv4;

FIG. 6 is a conceptual diagram illustrating basic operations of a mobile IPv6;

FIGS. 7-8 are flow charts illustrating FMIPv6 operations;

FIG. 9 is a flow chart illustrating a method for pre-configuration of an IP address in a mobile communication system according to one embodiment of the present invention;

FIG. 10 is a flow chart illustrating a method for pre-configuration of an IP address in a mobile communication system according to another embodiment of the present invention;

FIG. 11 is a flow chart illustrating a method for pre-configuration of an IP address in a mobile communication system according to still another embodiment of the present invention;

FIG. 12 is a flow chart illustrating a method for pre-configuration of an IP address in a mobile communication system according to still another embodiment of the present invention; and

FIG. 13 is a flow chart illustrating a method for pre-configuration of an IP address in a mobile communication system according to still another embodiment of the present invention.

### BEST MODE

Reference will now be made in detail to the preferred embodiments of the present invention, examples of which are illustrated in the accompanying drawings. Wherever possible, the same reference indexes will be used throughout the drawings to refer to the same or like parts.

One embodiment of the present invention provides a static method for acquiring IP address configuration—associated information using an information service or an information server, thereby performing pre-configuration of the IP address. In addition, another embodiment of the present invention provides a dynamic method for acquiring IP address configuration—associated information via a command service of a media independent handover (MIH), thereby performing pre-configuration of the IP address.

A communication system according to the embodiments of the present invention will hereinafter be described in detail.

The IEEE 802.21, which is conducting the international standardization of the Media Independent Handover (MIH) between heterogeneous networks, has a purpose of providing a seamless handover and service continuity between the heterogeneous networks, resulting in greater convenience for a user. The basic requirements of the IEEE 802.21 are a MIH function, an event trigger, and an information service.

The mobile node (MN) acts as a multi-mode node for supporting at least two interface types, and the interface may be set to any one of the following types. The above mentioned interface types comprise a wired-line format such as the IEEE 802.3-based Ethernet, a wireless interface based on the IEEE 802.XX, for example, the IEEE 802.11, the IEEE 802.15, and the IEEE 802.16, and an interface defined by the cellular standardization organization such as the 3GPP or 3GPP2.

However, the above-mentioned interface types are not limited to the above-mentioned examples, and can also be applied to other examples as necessary.

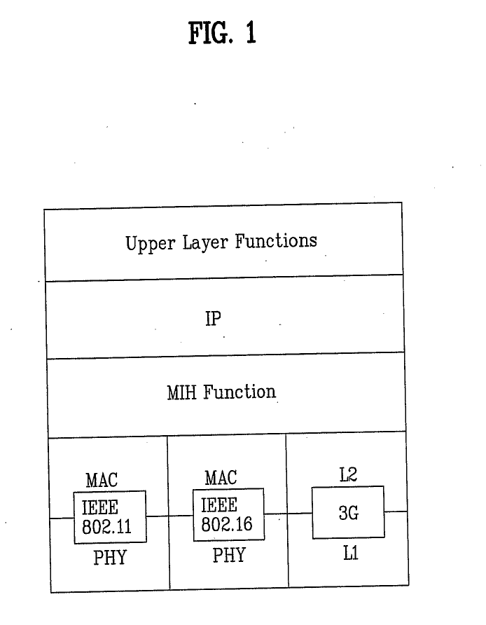

FIG. 1 is a structural diagram illustrating protocol layers of a multimode mobile node (MN).

Referring to FIG. 1, the multimode mobile node (MN) includes a physical layer (PHY) and a MAC (Medium Access Control) layer for each node. The MIH layer is located under the IP layer.

The MIH (Media Independent Handover) may be defined between IEEE 802-based interfaces, or may be defined between the 802-based interface and the non-802-based interface such as an interface defined by cellular standardization organization such as the 3GPP or 3GPP2. Preferably, the mobility-supporting protocol (e.g., mobile IP or SIP (Session Initiation Protocol)) of upper layers may be supported by the MIH function to provide a handover service or seamless service.

The mobile IPv4 will hereinafter be described in detail. The network for supporting a mobile IP includes a home agent (HA), a foreign agent (FA), and a mobile node (MN). A variety of functions are required to operate the mobile IP, such as, an agent discovery function, a registration function, a routing function, and a CoA.

1) Agent Discovery

The agent discovery function is indicative of a method for allowing a mobile node (MN) to determine whether the MN is connected to its own home network or a foreign network, such that it can recognize whether the MN has moved to another network.

2) Registration

According to the registration function, if the MN moves to another network, it transmits current location information to the home agent, and allows the MN to receive services which had received from the home network without any change, in such a way that the registration function provides a highly adaptable mechanism.

3) Routing

The routing function defines a variety of functions required for properly routing a datagram transmitted/received to/from the MN when the MN is connected to or accesses a foreign network.

4) CoA

The mobile IP provides two procedures (i.e., FA-CoA and co-located CoA) when the mobile terminal moves to another subnet, such that it can establish a temporary address (CoA) when the mobile terminal moves to another subnet.

If the FA-CoA is used, the FA-CoA is supplied from a foreign agent via an agent advertisement message, and an IP address of the foreign agent (FA) is used as a temporary address (CoA). If the co-located CoA is used, the mobile node receives a temporary address (CoA) via a DHCP server located at the foreign network.

The mobile IPv6 will hereinafter be described in detail. The mobile IPv6 can more effectively support the mobility than the mobile IPv4, and has a superior extensibility. The principal components for the mobile IPv6 operations, and functions of individual principal components will hereinafter be described in the following.

1) Mobile Node (MN)

A mobile node (MN) is a host or router for switching its network access.

2) Correspondent Node (CN)

A correspondent node (CN) is a host or router communicating with the mobile node (MN)

3) Home Agent (HA)

The home agent (HA) acts as a router, which has registration information of the mobile node (MN) from among routers contained in a home network, such that it transmits a datagram to a current position of the mobile node (MN) located in a foreign network. 4) CoA

The temporary address (CoA) is indicative of an IP address connected to a mobile node (MN) when the mobile node (MN) moves to a foreign node (FA).

5) Binding

The term “Binding” is indicative of a specific operation in which the mobile node (MN) matches the CoA to be registered in the home agent with a home address of a corresponding node.

6) Binding Update (BU)

The “Binding Update (BU)” message is indicative of a message used when the mobile node informs the home agent (HA) and the correspondent node (CN) with a CoA of the mobile node itself.

7) Binding Acknowledge (BACK)

The “Binding Acknowledge (BACK)” message is indicative of a response message to the aforementioned “BU” message.

8) Binding Request (BR)

The “Binding Request (BR)” message is indicative of a message for requesting the

“BU” message when the correspondent node (CN) does not receive the “BU” message until a timer for the binding information of the mobile node expires.

9) CoA Acquisition

The term “CoA acquisition” is indicative of a specific operation in which the mobile node automatically constructs its location information while in motion using a neighbor discovery function and an address auto-configuration function.

10) Router Optimization

The term “Router Optimization” is indicative of a specific procedure during which the correspondent node (CN) directly communicates with the mobile node without passing though the home agent after storing the binding information.

11) Address Auto-Configuration

The address auto-configuration function is classified into two address auto-configuration methods, i.e., a state-maintenance-type address auto-configuration method for acquiring an address using a server such as the DHCP server, and a non-state-maintenance-type address auto-configuration method for controlling a host to generate an address by itself.

The state-maintenance-type address auto-configuration method is adapted to assign one of addresses capable of being assigned from the server to the host on the condition that the host requests an address from the DHCP server.

The non-state-maintenance-type address auto-configuration method combines its interface ID information with either prefix information acquired from the router or well-known prefix information, such that it forms an address.

The FMIPv6 (Fast Handovers for Mobile IPv6) will hereinafter be described in detail.

The FMIPv6 is indicative of a specific protocol The FMIPv6 protocol quickly performs mobile detection and NCoA (new Care of Address) acquisition on the basis of handover-expected information at the L2 layer, such that it can reduce an overall handover delay in the L3 layer.

Principal components and messages for the FMIPv6 operations will hereinafter be described in the following.

1) Previous Access Router (PAR)

The PAR is indicative of a default router before a mobile node is handed over. 2) New Access Router (NAR)

The NAR is indicative of a default router expected when the mobile node is handed over.

3) Previous Care of Address (PCoA)

The PCoA is indicative of a reasonable temporary address of a mobile node in a PAR subnet.

4) New Card of Address (NCoA)

The NCoA is indicative of a reasonable temporary address of a mobile node in a NAR subnet.

5) Router Solicitation for Proxy (RtsolPr)

The RtsolPr is indicative of a specific message transmitted from the mobile node to the PAR, and requests a potential handover from the PAR. 6) Proxy Router Advertisement (PrRtAdv)

The PrRtAdv is indicative of a specific message transmitted from the PAR to the mobile node, provides neighbor link information, and acts as a trigger for a network-initiated handover.

7) Fast Binding Update (FBU)

The FBU is indicative of a specific message by which the mobile node requests the PAR to change a traffic reception place to the NAR.

8) Fast Binding Acknowledge (FBACK)

The FBACK is indicative of a response message to the FBU message generated by the PAR.

9) Handover Initiation (HI)

The HI is indicative of a specific message transmitted from the PAR to the NAR, and informs the NAR of a mobile-node handover.

10) Handover Acknowledge (HACK)

The HACK is indicative of a specific response message transmitted from the NAR to the PAR, and acts as a response message to the HI message.

11) Fast Neighbor Advertisement (FNA)

The FNA is indicative of a specific message transmitted from the mobile node to the NAR. If the mobile node does not receive the FBACK message yet, the FNA message confirms that the NCoA has been used, and informs the NAR that the mobile node gains access to a new network.

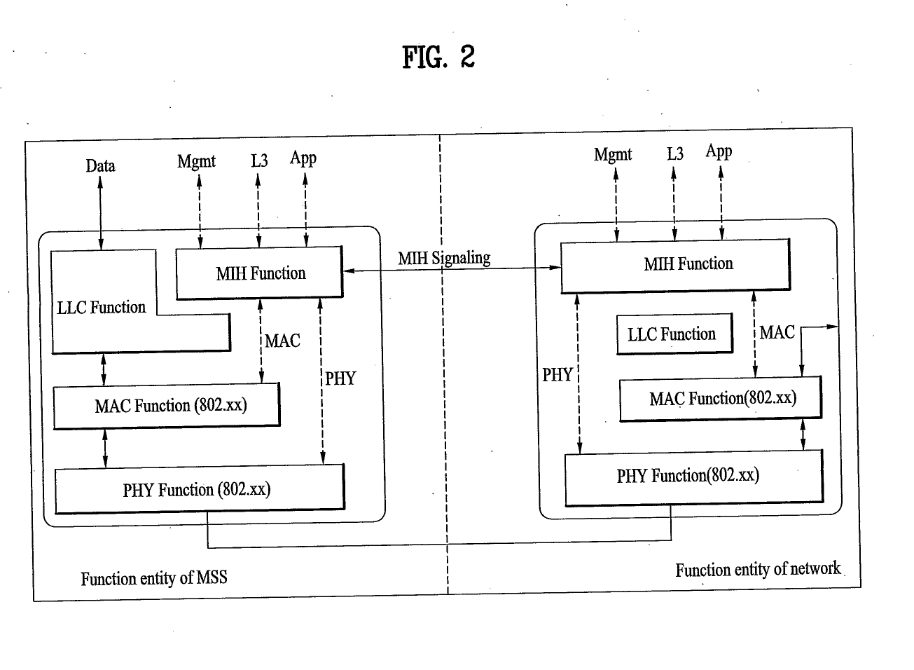

FIG. 2 is a conceptual diagram illustrating functional entities of a mobile node (MN) equipped with a MIH function, functional entities of a network, and transmission protocols. In FIG. 2, the dotted lines indicate primitive information and event trigger information, etc.

The MIH function is located under the IP layer, and facilitates the handover process using L2-layer input values such as a trigger event and information of other networks.

The MIH function may include input values based on user policy and configuration, such that it may affect the handover process, and defines general interfaces between the L3 entity (e.g., a mobile IP or a Session Initiation Protocol (SIP)) and the MIH function. The above-mentioned interfaces provide mobility management information associated with the L1 layer (i.e., Physical layer) and the L2 layer (i.e., MAC layer). The MIH layer acquires lower layer information and network information by the help of the event and the information service.

The upper layer includes an upper management entity for monitoring states and operations of various links contained in the mobile node (MN), such that it performs a handover control function and a device manager function. In this case, the handover control function and the device manager may be located at different locations independent of each other, or the handover control function and the device manager function may be included as the upper management entities in the upper layer.

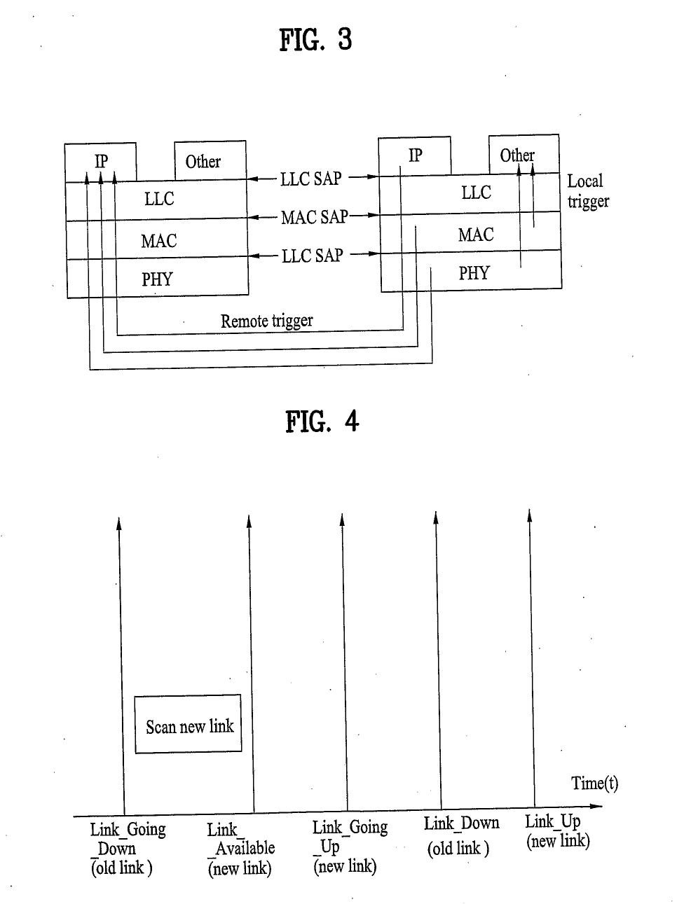

FIG. 3 is a conceptual diagram illustrating a trigger model.

Referring to the FIG. 3 the event trigger, which is one of the basic requirement for the MIH, will be described. First, the fast event service will be described.

In order to quickly perform a handover function, there is a need for a network layer to use information generated from a link layer, such that the network layer can quickly re-establish a connection state. The link layer event is adapted to predict the movement of a user, and helps a mobile terminal and a network to prepare the handover function.

A trigger for the handover may be initiated from the physical (PHY) layer and the MAC layer. A source of the trigger may be a local stack or a remote stack.

An event trigger provides state information of a current signal, state change information of another network, and future predicted change information, and includes change information of the physical and MAC layers or attribute change information of a specific network.

The event types can be classified into a physical (PHY) layer event, a MAC layer event, a management event, a third layer (L3) event, and an application event, etc.

Basic event services (i.e., “Link_Up” event, “Link_Down” event, “Link_Going_Down” event, “Link_Going_Up” event, “Link_Event_Rollback” event, “Link_Available” event, “Link_Parameters_Change” event, “MIH_Scan” event, and “Link_detected” event, etc.) will hereinafter be described in the following.

The “Link_Up” event occurs when a second layer (L2) connection is established on a specific link interface and an upper layer is able to transmit third layer (L3) packets. In this case, it is determined that all L2 layers contained in a link have been completely configured. A source of the “Link_Up” event corresponds to “Local MAC” and “Remote MAC”. The following Table 1 shows parameters of the “Link_Up” event.

TABLE 1

| Name | Type | Description |
|---|---|---|
| EventSource | EVENT_LAYER_TYPE | Source at which event occurs |
| EventDestination | EVENT_LAYER_TYPE | Destination to which event is to be |
| | | transmitted |
| MacMobileTerminal | MAC Address | MAC address of Mobile Terminal |
| MacOldAccessRouter | MAC Address | MAC address of old access router |
| MacNewAccessRouter | MAC Address | MAC address of new access router |
| NetworkIdentifier | Media Specific | Network ID used for detecting |
| | | subnet change |

The “Link_Down” event occurs when the L2 connection is released on a specific interface and L3 packets cannot be transmitted to a destination. The source of the “Link_Down” event is indicative of a local MAC. The following Table 4 shows parameters of the “Link_Down” event.

TABLE 2

| Name | Type | Description |
|---|---|---|
| EventSource | EVENT_LAYER_TYPE | Source at which event occurs |
| EventDestination | EVENT_LAYER_TYPE | Destination to which event is |
| | | to be transmitted |
| MacMobileTerminal | MAC Address | MAC address of Mobile Terminal |
| MacOldAccessRouter | MAC Address | MAC address of old access router |
| ReasonCode | | Reason for released link |

The “Link_Going_Down” event occurs when it is expected that the L2 connection will enter a “Link_Down” state within a predetermined time, and may serve as a signal for initializing a handover procedure. A source of the “Link_Going_Down” corresponds to “Local MAC” and “Remote MAC”. The following Table 3 shows parameters of the “Link_Going_Down” event.

TABLE 3

| Name | Type | Description |
|---|---|---|
| EventSource | EVENT_LAYER_TYPE | Source at which event occurs |
| EventDestination | EVENT_LAYER_TYPE | Destination to which event is to be |
| | | transmitted |
| MacMobileTerminal | MAC Address | MAC address of Mobile Terminal |
| MacOldAccessRouter | MAC Address | MAC address of old access router |
| MacNewAccessRouter | MAC Address | MAC address of new access router |
| TimeInterval | Time in msecs | Predicted Link_Down time of link |
| ConfidenceLevel | % | Link_Down level predicted at specific |
| | | time |
| UniqueEventIdentifier | | Use in event rollback occurrence |

The “Link_Going_Up” event occurs when it is expected that the L2 connection will enter a “Link_Up” state within a predetermined time, and is used when a long period of time is consumed to initialize a network. A source of the “Link_Going_Up” event corresponds to “Local MAC” and “Remote MAC”. The following Table 4 shows parameters of the “Link_Going_Up” event.

TABLE 4

| Name | Type | Description |
|---|---|---|
| EventSource | EVENT_LAYER_TYPE | Source at which event occurs |
| EventDestination | EVENT_LAYER_TYPE | Destination to which event is to be transmitted |
| MacMobileTerminal | MAC Address | MAC address of Mobile Terminal |
| MacNewAccessRouter | MAC Address | MAC address of new access router |
| TimeInterval | Time in msecs | Predicted Link_UP time of link |
| ConfidenceLevel | % | Link_UP level predicted at specific time |
| UniqueEventIdentifier | | Use in event rollback occurrence |

The “Link_Event_Rollback” event is formed by combining the “Link_Going_Down” event with the “Link_Going_Down” event. The “Link_Event_Rollback” event is indicative of a trigger generated when it is expected that the “Link_UP” event or “Link_Down” event will not be generated any more within a specific time on the condition that the “Link_Going_Up” event or “Link_Going_Down” event are transmitted to a destination. A source of the “Link_Event_Rollback” event corresponds to “Local MAC” and “Remote MAC”. The following Table 5 shows parameters of the “Link_Event_Rollback” event.

TABLE 5

| Name | Type | Description |
|---|---|---|
| EventSource | EVENT_LAYER_TYPE | Source at which |
| | | event occurs |
| EventDestination | EVENT_LAYER_TYPE | Destination to which |
| | | event is to be |
| | | transmitted |
| MacMobileTerminal | MAC Address | MAC address of |
| | | Mobile Terminal |
| MacNewAccessRouter | MAC Address | MAC address of |
| | | new access router |
| UniqueEventIdentifier | | Use in event |
| | | rollback occurrence |

The Link_Available” event is indicative of an available state of a new specific link, and indicates the possibility of allowing a new base station (BS) or a new Access Point (AP) to provide a superior link quality as compared to a current BS or a current AP to which a current mobile terminal is connected. A source of the “Link_Available” event corresponds to “Local MAC” and “Remote MAC”. The following Table 8 shows parameters of the “Link_Available” event.

TABLE 6

| Name | Type | Description |
|---|---|---|
| EventSource | EVENT_LAYER_TYPE | Source at which |
| | | event occurs |
| EventDestination | EVENT_LAYER_TYPE | Destination to which |
| | | event is to be |
| | | transmitted |
| MacMobileTerminal | MAC Address | MAC address of |
| | | Mobile Terminal |
| MacNewAccessRouter | MAC Address | MAC address of |
| | | new access router |
| MacOldAccessRouter | MAC Address | MAC address of |
| | | old access router |

The “Link_Parameter_Change” event is indicative of an event generated when a change of a link parameter value is higher than a specific threshold level. The “Link_Parameter_Change” event includes link layer parameters, for example, a link speed (i.e., a link rate), a QoS (Quality of Service), and an encrypted value, etc. A source of the “Link_Parameter_Change” event corresponds to “Local MAC” and “Remote MAC”. The following Table 7 shows parameters of the “Link_Parameter_Change” event.

TABLE 7

| Name | Type | Description |
|---|---|---|
| EventSource | EVENT_LAYER_TYPE | Source at |
| | | which event |
| | | occurs |
| EventDestination | EVENT_LAYER_TYPE | Destination to |
| | | which event is |
| | | to be |
| | | transmitted |
| MacMobileTerminal | MAC Address | MAC address |
| | | of Mobile |
| | | Terminal |
| MacAccessRouter | MAC Address | MAC address |
| | | of new access |
| | | router |
| oldValueOfLinkParameter | | Old value of |
| | | link |
| | | parameters |
| newValueOfLinkParameter | | New value of |
| | | link parameters |

The “MIH_Scan” event is indicative of a command for enabling an upper layer to search for peripheral access points of a current access network. If the MIH_Scan” event is generated when the upper layer entity desires to scan available access networks. If several links are requested by the upper layer entity, several Link_Scan commands can be initiated along with individual media scan request information.

The “Link_Detected” event indicates that a new specific link is in a Link-available status. The “Link_Detected” event indicates a possibility that a new base station (BS) or access point may provide the link quality better than that of a current base station (BS) or access point (i.e., a current connection point).

The event source parameters (i.e., Local MAC and Remote MAC) are shown in the following Table 8:

TABLE 8

| Name | Type | Description |
|---|---|---|
| EventSource | EVENT_LAYER_TYPE | Source at which |
| | | event is generated |
| EventDestination | EVENT_LAYER_TYPE | Destination at which |
| | | event is received |
| MacMobileTerminal | MAC Address | MAC address of |
| | | mobile node (MN) |
| MacNewAccessRouter | MAC Address | MAC address of |
| | | new access router |
| MacOldAccessRouter | MAC Address | MAC address of old |
| | | access router |

Primitives capable of being used for the MIH handover will hereinafter be described. There are a variety of primitives, for example, the MIH_Handover_Initiate.request primitive, the MIH_Handover_Initiate.response primitive, MIH_Handover_Commit.request primitive, and the MIH_Handover_Commit.response primitive.

MIH_Handover_Initiate.request

The MIH_Handover_Initiate.request primitive is adapted when the upper layer entity transmits the presence of handover initiation intention to the MIH functions of the MN and the network, such that the MIH functions of the MN and the network can recognize the handover initiation intention via the upper layer entity.

MIH_Handover_Initiate.response

The MIH_Handover_Initiate.response primitive is a response message to the MIH_Handover_Initiate.request primitive, selects a priority link according to requested link situations, and indicates the selected link information.

MIH_Handover_Commit.request

The MIH_Handover_Commit request primitive informs an old access point (AP) that an actual handover for the selected link begins, such that the old AP starts buffering data to be forwarded to the mobile node (MN). This primitive can be classified as MIH_Net_HO_Commit.request and MIH_MN_HO_Commit.request according to whether Network or MN transmits this primitive.

MIH_Handover_Commit.response

The MIH_Handover_Commit.response primitive is indicative of a response message to the The MIH_Handover_Commit.request primitive, and indicates whether the handover is successfully performed or not. This primitive can be classified as MIH_Net_HO_Commit.response and MIH_MN_HO_Commit.response according to whether Network or MN transmits this primitive.

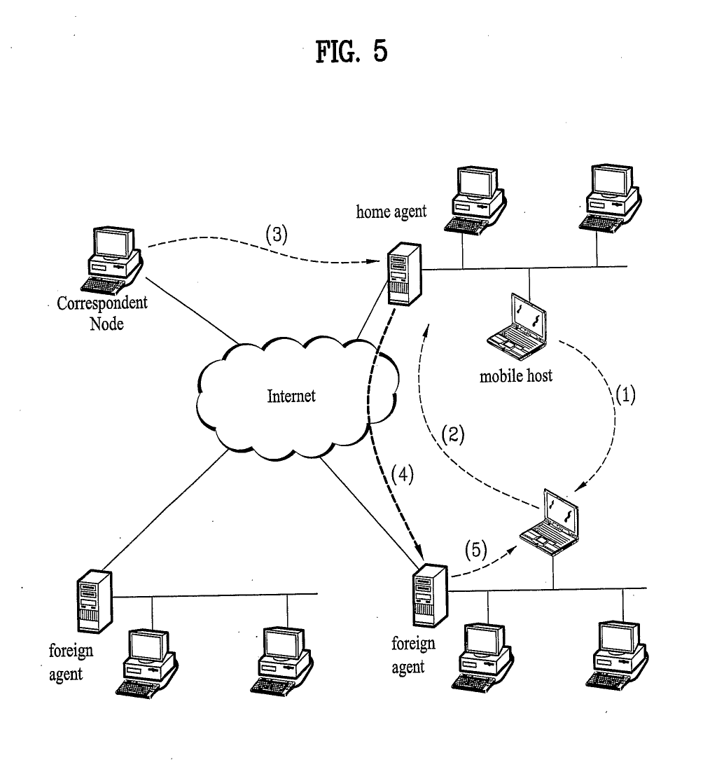

FIG. 4 is an exemplary diagram illustrating triggers generated until a mobile node (MN) establishes a new link due to a quality deterioration of a link currently connected to the mobile node (MN).

The information service will hereinafter be described as the last element from among the above-mentioned basic requirements for the handover.

The above-mentioned information service enables a user to easily find or select a desired network from among a variety of networks. This information service (IS) can be accessed by all the networks.

The MIIS (media independent information service) includes the following information elements, for example, a Link access parameter, a Security mechanism, a Neighbor Map, a Location, a Provide and other Access Information, and a Cost of Link, etc.

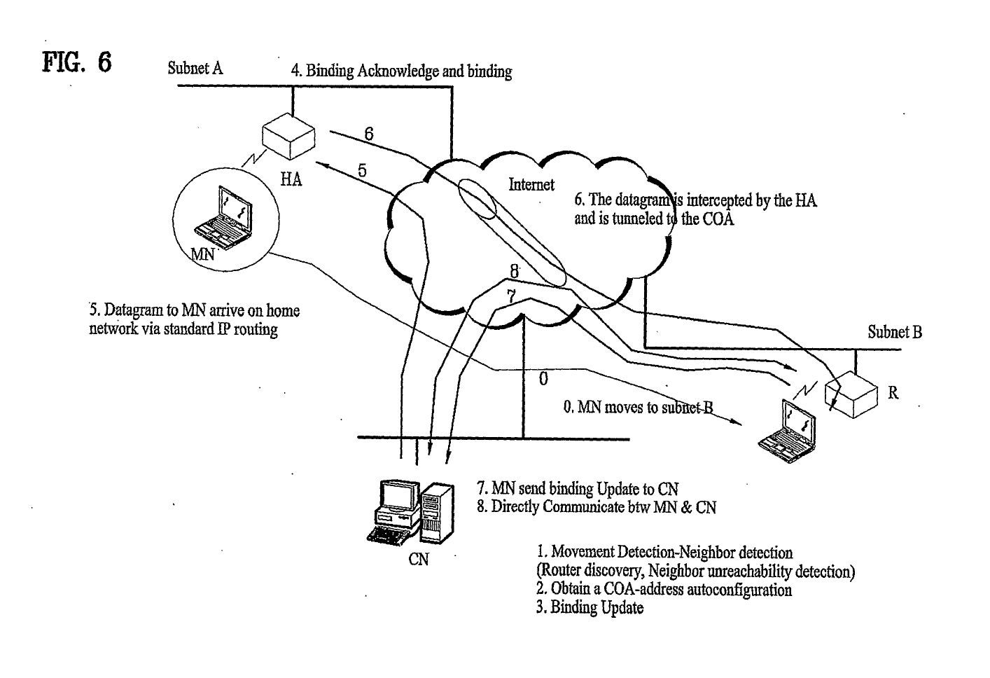

FIG. 5 is a conceptual diagram illustrating basic operations of the mobile IPv4.

Basically, the mobile IPv4 aims to provide upper layers with transparent mobility. In order to support the transparent mobility, the mobile IPv4 may further include a mobile host, a home agent, and a foreign agent.

However, if the router optimization function is not used, there is no need to change a correspondent node communicating with the mobile node (MN) to another node.

In this case, the mobile host is indicative of an IP host to which the mobility is supported. The home agent is a router for maintaining location information of the mobile host, and performs tunneling of the foreign agent or the mobile host. The foreign agent is indicative of a router for supporting the mobility in the foreign network. Basic operations of the mobile IPv4 are shown in FIG. 5.

Detailed description of individual operations of the mobile IPv4 are shown in the following steps 1)˜5).

1) Step 1

If the mobile host moves from its home network to a foreign network, it receives an advertisement message broadcast from the foreign network, such that it recognizes that the mobile host itself has moved to the foreign network. And, the mobile host registers a temporary address (CoA) indicating the mobile host's current location in the home agent contained in the home network.

2) Step 2

In this case, the CoA may be a FA-CoA indicating an IP address of the foreign agent or a Co-located CoA. The Co-located CoA is temporarily assigned from the foreign network to the mobile host via a DHCP, etc. The packets transmitted from an external part to the mobile host are applied to the home network, and are snatched by the home agent recognizing the movement of the mobile node (MN).

3) Step 3

If the FA-CoA is used, the home agent performs encapsulation of packets to be transmitted to the mobile host, and transmits the encapsulated packets to the foreign agent, such that the FA's address is determined to be a destination of the above packets.

4) Step 4

Encapsulated packets are de-capsulated by the foreign agent, the de-capsulated packets are recovered to initial transmission packets, such that the recovered packets are finally transmitted to the mobile host.

5) Step 5

Packets transmitted from the mobile host to a correspondent host can be directly transmitted via the foreign agent. If an ingress filtering problem occurs, the above-mentioned packets may also be transmitted via a reverse tunnel.

The principal functions required for the mobile IP are an agent discovery function, a registration function, and a routing function, etc., and their detailed description will hereinafter be described.

1) Agent Discovery

The agent discovery is indicative of a method for allowing a mobile node (MN) to determine whether the mobile node (MN) is connected to its own home network or a foreign network, such that the mobile node (MN) can recognize whether the mobile node (MN) itself has moved to another network.

The mobile IP extends a conventional ICMP (Internet Control Message Protocol) Router Discovery (i.e., IETF RFC 1256) to discover a desired agent.

The agent advertisement message periodically broadcast by the agents (i.e., home agent, and foreign agent) includes a “Mobility Agent Advertisement Extension” message in an “ICMP Router Advertisement” message, and transmits the “ICMP Router Advertisement” message including the a “Mobility Agent Advertisement Extension” message.

An “Agent Solicitation” message transmitted when the mobile node (MN) searches for an agent employs the same method as in a conventional “ICMP Router Solicitation” message.

2) Registration

If the mobile node (MN) moves to another network, the registration function transmits current location information of the mobile node (MN) to the home agent, and allows the mobile node (MN) to receive services from the home network without any change.

The mobile IP provides two registration procedures (i.e., FA-CoA and co-located CoA).

If the mobile node (MN) uses the FA-CoA, it performs registration via the foreign agent (FA). If the mobile node (MN) uses the co-located CoA, the mobile node (MN) directly performs registration to the home agent.

3) Routing

The routing function defines a variety of functions required for properly routing a datagram transmitted/received to/from the mobile terminal when the mobile node (MN) is connected to or accesses a foreign network. The datagram includes a unicast packet, a multicast packet, and a broadcast packet.

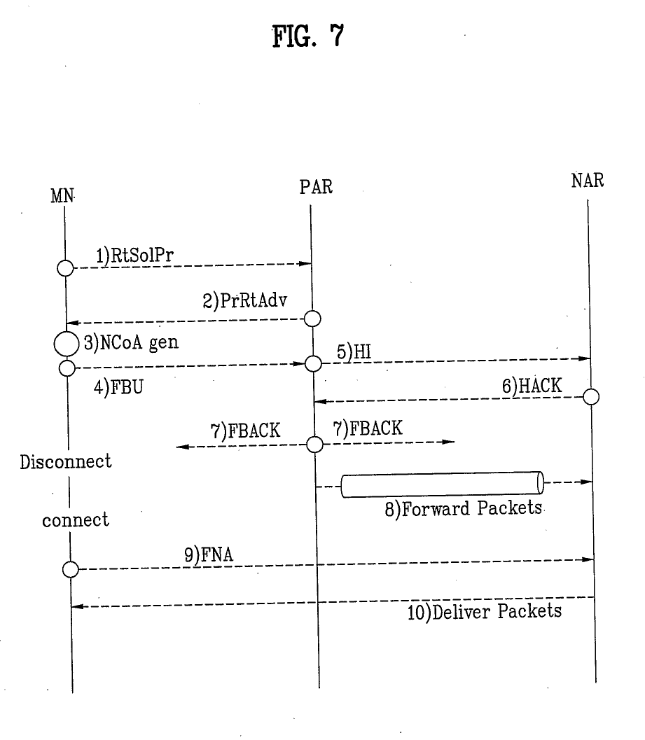

FIG. 6 is a conceptual diagram illustrating basic operations of a mobile IPv6. Operations of the mobile IPv6 will hereinafter be described with reference to FIG. 6.

The MN moves from the subnet A to the subnet B at step (0).

The MN detects the movement of the MN using not only the prefix information of the RA message but also NUD (Neighbor Unreachable Detection) mechanism at step (1).

The MN acquires the CoA by itself using the Address auto-configuration method at step (2).

The MN transmits the BU message to inform the HA of the acquired CoA at step (3).

The HA binds the home address of the MN with the CoA of the MN, and transmits the Back message to answer the BU message at step (4).

The CN initially communicating with the MN does not detect the movement of the MN, such that it determines a destination address to be the MN home address, and transmits the packets to the destination at step (5).

The HA managing the MN snatches the packets, and performs tunneling of the packets to the location of a current MN at step (6).

Upon receiving the tunneled packets, the MN determines that the CN which has transmitted the packets does not have binding information, and transmits the BU message to the CN, such that it informs the CN of the MN's CoA at step (7).

If the CN stores the binding information, it directly communicates with the MN using the stored binding information at step (8).

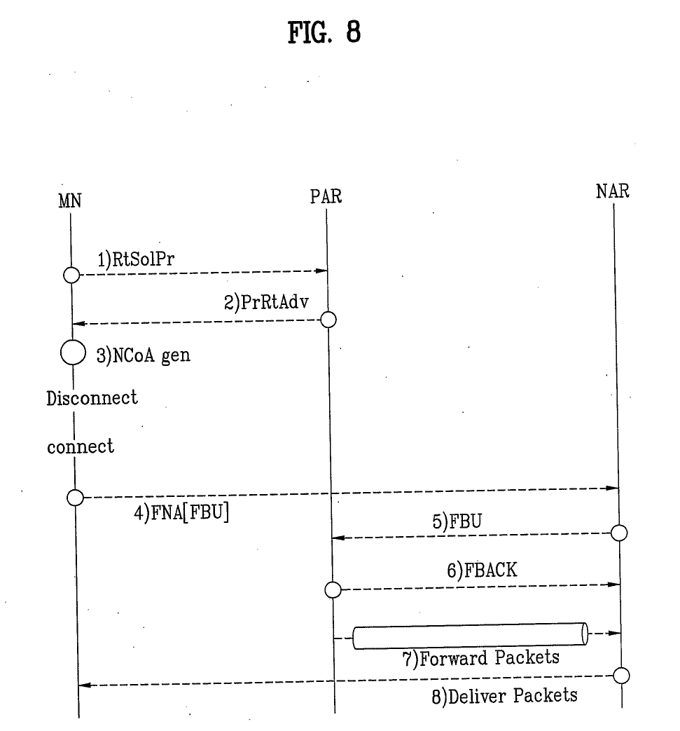

FIGS. 7˜8 are flow charts illustrating FMIPv6 operations.

Specifically, FIG. 7 shows operation procedures of the proactive status and FIG. 8 shows operations procedures of the reactive status.

The proactive status indicates the FBU/FBACK messages are transmitted or received to/from the PAR's link. The reactive status indicates that the FBU/FBACk messages are transmitted or received to/from the NAR's link. The proactive status examines the certainty of NCoA created before the connection to the PAT is released. The reactive status checks the certainty of NCoA after the mobile node reaches a new subnet.

Detailed description of operations of the proactive status will be described referring to the following steps 1)˜10) of FIG. 7.

1) Step 1

The mobile node discovers handover-enable APs on the basis of L2-layer information (e.g., the scanning of a wireless LAN system), and transmits the RtSolPr message to the PAR to acquire subnet information corresponding to the AP identifiers.

2) Step 2

If the PAR receives the RtSolPt message, it includes AP-Id or AR-Info tuples in individual subnet information corresponding to the transmitted APs, and transmits the PrRtAdv message to the mobile node. Sometimes, the PrRtAdv message may be solicitously transmitted after the mobile node performs router detection.

3) Step 3

The mobile node generates a new CoA (NCoA) on the basis of the AR-Info tuple contained in the PrRtAdv message.

4) Step 4

The mobile node requests the binding between the PCoA and the NCoA from the PAR, and transmits the FB message, such that the packets reaching the PAR can be tunneled to the NAR.

5) Step 5

The PAR transmits the HI message indicating that the mobile node will be handed over to the NAR. The NAR receiving the HI message performs double examination of the NCoA generated by the mobile node. If it is determined that the NCoA is improper by the double examination, the NAR re-establishes the CoA for the mobile node.

6) Step 6

The NAR transmits the HACK message to the PAR, such that it is used as a response message to the HI message. In this case, the NCoA created by the step 5 may be included in the HACK message as necessary.

7) Step 7

The PAR receiving the HACK message transmits the FBACK message to the mobile node and the NAR, and indicates that the PAR begins to perform tunneling of the mobile node's packets to the actual NCoA address. In this case, the connection between the mobile node and the PAR is severed.

8) Step 8

The packets reaching the PAR are forwarded to the NAR.

9) Step 9

The mobile node transmits the FNA message to the NAR as soon as a new link between the mobile node and the NAR is established, such that it informs the NAR that the mobile node itself is connected to the NAR's network.

10) Step 10

The packets are transmitted via the NAR.

Detailed description of operations of the reactive status will be described referring to the following steps 1)˜8) of FIG. 8.

1) Step 1

The mobile node discovers handover-enable APs on the basis of L2-layer information (e.g., the scanning of a wireless LAN system), and transmits the RtSolPr message to the PAR to acquire subnet information corresponding to the AP identifiers.

2) Step 2

If the PAR receives the RtSolPt message, it includes AP-Id or AR-Info tuples in individual subnet information corresponding to the transmitted APs, and transmits the PrRtAdv message to the mobile node. Sometimes, the PrRtAdv message may be solicitously transmitted after the mobile node performs router detection.

3) Step 3

The mobile node generates a new CoA (NCoA) on the basis of the AR-Info tuple contained in the PrRtAdv message, and releases the connection to the PAR

4) Step 4

The mobile node encapsulates the FBU message in the NFA message as soon as it is connected to the NAR, and transmits the encapsulated result, such that it begins to perform a specific procedure for immediately forwarding the packets received in the PAR to the NAR, and commands the NAR to determine whether the NCoA is valid or not.

5) Step 5

The NAR transmits the FB message to the PAR, such that the PAR binds the PCoA with the NcoA by the FB message. If it is determined that the NCoA is invalid by the FBU message received in the NAR, the NAR discards the FBU packets, and transmits a router advertisement message including a substitute address.

6) Step 6

The PAR transmits the FBACK message to the NAR to answer the FBU message. In this case, the tunneling is completely established between the actual PAR and the NAR.

7) Step 7

The packets arriving at the PAR are forwarded to the NAR.

8) Step 8

The packets are transmitted via the NAR.

A variety of methods for pre-configuration of an IP address according to the embodiments of the present invention will hereinafter be described, for example, a method for acquiring IP address configuration—associated information using the information service or the information server, and a method for acquiring IP address configuration—associated information via a Media Independent Handover (MIH) command service.

For the convenience of description, the first method will hereinafter be described.

The following Table 9 exemplarily information elements (IEs) showing the PoA (Point of Attachment) Container received from the information server when the information service is used.

TABLE 9

Type=TYPE_CONTAINER_POA Length= Variable
PoA Location IE
PoA Data Rate IE
PoA MAC Type IE
PoA Channel Range IE
PoA Subnet Information IE
PoA Capabilities IE
PoA IP Configuration Methods IE
PoA PHY Type IE
PoA Address IE
Vender Specific PoA IE (optional)

As can be seen from Table 9, the PoA Container information includes all the information elements associated with the PoA. It can be recognized that the PoA IP Configuration Methods IE message for pre-configuration of the IP address from among the above-mentioned information elements is contained as the information elements in the above Table 9.

The following Table 10 information elements (IEs) showing the PoA IP Configuration Methods IE.

TABLE 10
Type=TYPE_IE_POA_IP_CONFIG_METHODS Length= Variable
IP_configuration_methods_bitmap [4 octets]
DHCP_server_address TLV [variable]
Foreign Agent or Access Router Address TLV [variable]

As can be seen from Table 10, the PoA IP Configuration Methods IE message includes information associated with a method for configuration of the IP address capable of being used by a new CoA after the mobile node (MN) had performed the handover (e.g., IP_Configruation_Methods_bitmap).

According to the IP address configuration methods, the PoA IP configuration Methods IE message may further include information required for the IP address configuration (e.g., DHCP server IP address, Foreign Agent IP address information, or Access Router IP address information). For example, when “IPv4 dynamic configuration (DHCPv4)”, “Mobile IPv4 without FA (Co-located CoA)” or “IPv6 stateful address configuration (DHCPv6)” is supported, the dynamic host configuration protocol (DHCP) Server address TLV, as shown in the following table 12, may be included to allow pre-configuration of IP address. Similarly, when “Mobile IPv4 with FA (FA-CoA)”, or “IPv6 stateless address configuration” is supported, Foreign Agent or Access Router Address TLV, as shown in the following table 13, indicating a foreign agent or access router address may be included to allow pre-configuration of IP address.

The following Table 11 exemplarily shows the IP_Configuration_Methods_bitmap message indicating the IP configuration method supported by the PoA from among parameters of the PoA IP Configuration Methods IE message.

TABLE 11

| | |
|---|---|
| Bit 0 | IPv4 static configuration |
| Bit 1 | IPv4 dynamic configuration (DHCPv4) |
| Bit 2 | Mobile IPv4 with FA (FA-CoA) |
| Bit 3 | Mobile IPv4 without FA (Co-located CoA) |
| Bits 4-10 | Reserved for IPv4 address configurations |
| Bit 11 | IPv6 stateless address configuration |
| Bit 12 | IPv6 stateful address configuration (DHCPv6) |
| Bit 13 | IPv6 manual configuration |
| Bits 14-31 | Reserved. |

In Table 11, it is assumed that the Bit 1 (i.e., IPv4 dynamic configuration (DHCPv4)), the Bit 3 (i.e., Mobile IPv4 without FA (Co-located CoA)), and the Bit 12 (i.e., IPv6 stateful address configuration (DHCPv6)) are supported and established. As a result, the DHCP_server_address TLV including the DHCP server address information may be included in PoA IP Configuration Methods IE message, such that the resultant message may be transmitted to a destination.

The DHCP server address is indicative of an IP address of a DHCP server. The DHCP server will be connected to the mobile node (MN) if the mobile node (MN) goes to a new PoA and establishes the IP address to be used. The mobile node (MN) gains access to the DHCP server of the new AP (PoA) using the IP address received via the DHCP_Server_address TLV message created prior to the handover, such that it may pre-establish the IP address.

The following Table 12 exemplarily shows the DHCP_server_address TLV format structure.

TABLE 12

Type=TYPE_IE_POA_DHCP_SERVER_ADDRESS Length=
Variable
An_IP_address (IPv4 or IPv6)
(4-octet for IPv4 or 16-octet for IPv6)

The IP address value capable of being included in the DHCP_server_address TLV message may indicate an IPv4 or IPv6 address of a DHCP server

It is assumed that the Bit 2 (i.e., Mobile IPv4 with FA (FA-CoA)) or the Bit 11 (i.e., IPv6 stateless address configuration is supported and established, and the resultant message is transmitted. In this case, the Foreign Agent or Access Router Address TLV message may be contained in the resultant message, such that the resultant message including the Foreign Agent or Access Router Address TLV message is transmitted to a destination, such that the mobile node (MN) can pre-establish the IP address.

The following Table 13 exemplarily shows the Foreign Agent or Access Router Address TLV format structure.

TABLE 13

Type=TYPE_IE_POA_FA_AR_ADDRESS Length= Variable
An_IP_address (IPv4 or IPv6)
(4-octet for IPv4 or 16-octet for IPv6)

Referring to Table 13, the IP address contained in the Foreign Agent or Access Router Address TLV message is indicative of an IP address of an entity (e.g., the foreign agent or the access router) for acquiring a valid IP address. In more detail, if the mobile IP client or the IPv6 client of using the stateless address configuration contacts the network including the PoA to be connected to the mobile node after the handover, the entity can acquire the valid IP address capable of being used in the network equipped with the FoA. Prior to the handover, this IP address may be used for the mobile node (MN) to pre-establish the IP address to be used at a new access point (AP).

Preferred embodiments of the above-mentioned method for receiving the IP address—associated information via the information service or the information server to establish the IP address prior to the handover will hereinafter be described in detail.

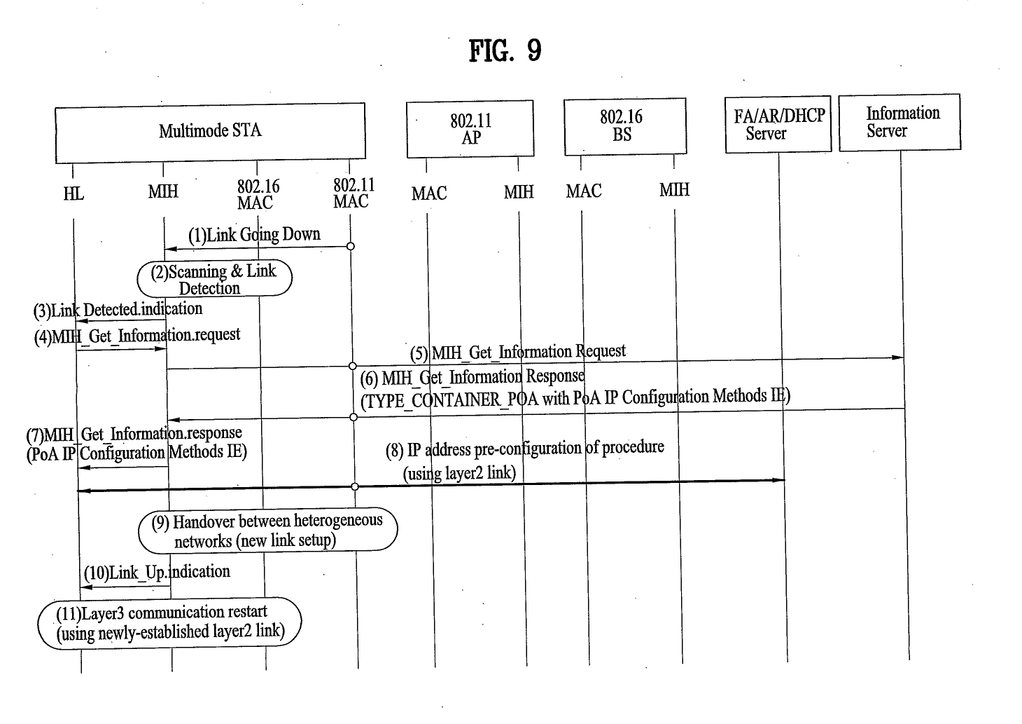

FIG. 9 is a flow chart illustrating a method for pre-configuration of an IP address in a mobile communication system according to a preferred embodiment of the present invention.

A representative example for pre-configuration of the IP address using the IP address—associated information acquisition based on the information service is shown in FIG. 9.

1) Step 1

The mobile node (MN) receives a Link_Going)Down message from the currently-connected link layer (802.11 MAC). The Link_Going_Down message indicating the link setup will be released due to a bad or poor link status of a current link, such that the mobile node (MN) can recognize that the link will be released due to the poor link status or the network status.

2) Step 2

If the mobile node (MN) is a multimode terminal (i.e., a multimode STA), it detects another networks (candidate networks) to which the MN is to be handed over using the scanning operation.

3) Step 3

If the presence of the detected network is determined, the MN informs the upper management entity (HL) of multimode STA of the detected network, as denoted by “Link_Detected.indication”.

4) Step 4

The upper management entity (HL) request the MIH function entity for transmitting to the information server a request message for requesting IP configuration method of PoA or PoS (point of service) to which the MN is about to move and IP address information to be used for the object to be contacted for this.

5) Step 5

The MIH function entity transmits a remote message for requesting information according to a request of the upper management entity (HL) to the information server. In this case, a current access link may be used as a wireless link used for transmitting the above-mentioned remote message. In the case of using a link of an AP to which the MN is to be handed over, the remote message may also be transmitted over the link of the above-mentioned AP.

6) Step 6

The information server transmits a response message including a response to the requested information to the MIH function entity at a remote site.

In this case, the wireless link may use a current access link in the same manner as in the step 5. If the MN may use the link of the handover AP, the response message may also be transmitted via the link of the handover AP.

7) Step 7

If the MIH function receives the response message, it transmits the received information to the HL.

8) Step 8

The MN contacts the entity acquired by the response information, and performs pre-configuration of the IP address.

9) Step 9

The MN performs a handover procedure including a new-link setup process.

10) Step 10

In the case where the new wireless link setup is terminated by the completion of the handover, the HL receives information indicating the above case.

11) Step 11

The MN need not perform configuration of an additional IP address after the handover because it performed pre-configuration of the IP address before the handover, and the MN transmits upper packets to the newly-established wireless link via the IP link.

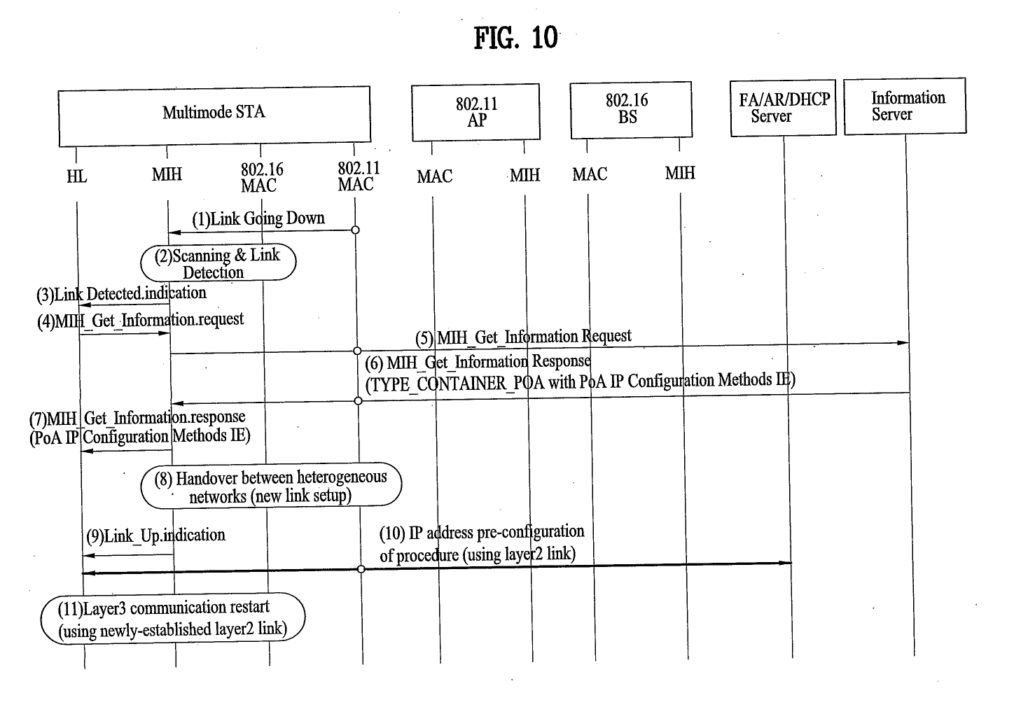

FIG. 10 is a flow chart illustrating a method for pre-configuration of an IP address in a mobile communication system according to another preferred embodiment of the present invention.

Prior to describing operations of FIG. 10, it should be noted that the steps 1)˜7) are equal to those of FIG. 9, such that their detailed description will herein be omitted for the convenience of description.

Referring to FIG. 10, according to the IP address configuration procedure, the multimode STA connects a link to a target access point (AP), receives the link setup completion message via the Link_Up.indication message, and connects a new link (i.e., a layer2 link) to the target AP, such that the IP address configuration procedure can be performed as shown in the following steps 8)˜11).

8) Step 8

The multimode STA performs a handover procedure including a new-link setup process.

9) Step 9

In the case where the new wireless link setup is terminated by the completion of the handover, the HL receives information indicating the above case.

10) Step 10

The multimode STA contacts the entity acquired by the response information, and performs pre-configuration of the IP address. Preferably, the IP address may be pre-configured by the new link (i.e., Layer2 link) established by the step 8.

11) Step 11

Since the multimode STA pre-establishes the IP address before the handover, there is no need to perform configuration of an additional IP address after the handover, and the multimode STA may transmit upper packets to the newly-established wireless link via the IP link.

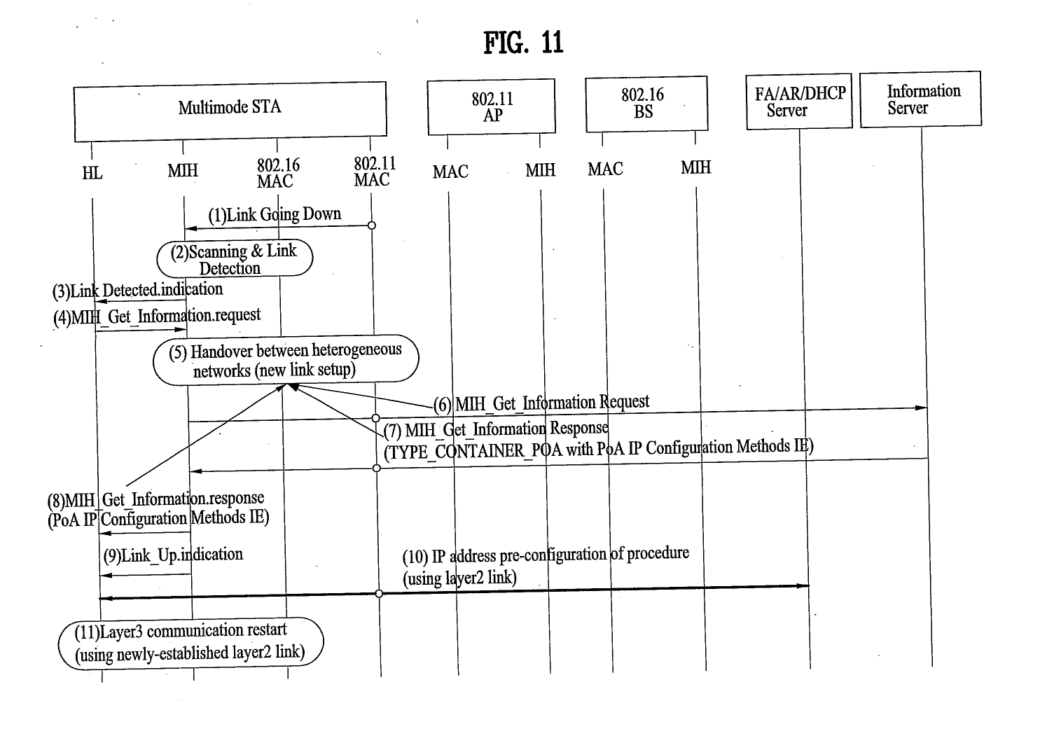

FIG. 11 is a flow chart illustrating a method for pre-configuration of an IP address in a mobile communication system according to another preferred embodiment of the present invention.

Prior to describing operations of FIG. 11, it should be noted that the steps 1)˜3) of FIG. 9 are equal to those of FIG. 11.

According to the preferred embodiment of FIG. 11, the multimode STA may acquire IP address configuration—associated information from the information server while it connects a link to a target AP. In this case, the MIH protocol message for acquiring the IP address configuration information may be encapsulated in a corresponding layer2 management frame or a layer2 management message, such that the encapsulated resultant message may be transmitted to a destination. A detailed description thereof is shown in the following steps 4)˜11).

4) Step 4

The upper management entity (HL) establishes a method for configuration of an IP address to be used by a PoA or PoS to which the MN is to be handed over, and requests IP address information of an entity to be contacted from the MIH function entity, such that the IP address information is transmitted to the information server. The step 4 may also be performed while the multimode STA connects a link to a target AP as necessary.

5) Step 5

The multimode STA performs the handover including a new link setup process. The following steps 6) and 7) may be executed during the step 5 indicating the new link setup process. Preferably, the following step 8 may also be executed during the step 5.

6) Step 6

The MIH function entity transmits a remote message for requesting information according to a request of the upper management entity (HL) to the information server. In this case, a current access link may be used as a wireless link used for transmitting the above-mentioned remote message. In the case of using a link of an AP to which the MN is to be handed over, the remote message may also be transmitted over the link of the above-mentioned AP.

7) Step 7

The information server transmits a response message including a response to the requested information to the MIH function entity at a remote site.

In this case, the wireless link may use a current access link in the same manner as in the step 5. If the MN may use the link of the handover AP, the response message may also be transmitted via the link of the handover AP.

8) Step 8

If the MIH function receives the response message, it transmits the received information to the HL.

9) Step 9

In the case where the new wireless link setup is terminated by the completion of the handover, the HL receives information indicating the above case.

10) Step 10

The multimode STA contacts the entity acquired by the response information, and pre-establishes the IP address. Preferably, the IP address may be pre-established by the new link (i.e., Layer2 link) established by the step 5.

11) Step 11

Since the multimode STA pre-establishes the IP address before the handover, there is no need to establish an additional IP address after the handover, and the multimode STA may transmit upper packets to the newly-established wireless link via the IP link.

Different entities for commanding the IP address configuration are generated according to the IP address configuration methods acquired from the IP address configuration—associated information.

For example, a currently-used IP address configuration method assumes the mobile IPv4 based on the foreign agent. And, it is assumed that an IP address configuration method to be used at a target AP is a DHCP version 4. In this case, if the Layer2 link setup procedure associated with a new AP is completed, the DHCP version4-entity contained in the multimode STA receives an IP address configuration command, thereby performing the IP address configuration process.

A method for employing the command service to perform pre-configuration of the IP address will hereinafter be described in detail.

In order to implement the command service, the present invention exemplarily discloses a method for pre-configuration of the IP address by transmission/reception of the network address information messages. For example, there are primitive-format messages communicated in the local stack and the protocol message communicated at a remote site.

The MIH_Network_Address_Information message indicating the primitive-format message will hereinafter be described in detail.

1. MIH_Network_Address_Information.request

1) Function:

The MIH_Network_Address_Information.request primitive is transmitted from the MIF function entity of the multimode STA (or MN) to a current PoS (Point of Service) or PoA (Point of Attachment). The current PoS or PoA is a current access entity of the multimode STA before the handover. If there is a new PoS or PoA to which the multimode STA is to be handed over, the above-mentioned current PoS or PoA or may also be called an old PoS or PoA.

The current PoS or PoA transmits the MIH_Network_Address_Information.request primitive to the MIH function contained in the new PoS or PoA to discover information associated with the network address (i.e., IP address) of the multimode STA. If the multimode STA establishes a link to the new PoS or PoA and transmits data via the established link, it may directly transmit data to the MIH function entity of the new PoS or PoA.

Upon receiving the MIH_Network_Address_Information.request primitive, the MIH function entity of the new PoS or PoA requests information of a network address (i.e., IP address) from the upper layer, acquires the requested information, and transmits the acquired information to the access router or foreign agent. In this case, the access router or the foreign agent includes the MIH function entity including a large amount of network-requested information. In this case, a specific entity (e.g., access router or foreign agent) including corresponding information in a network may directly transmit the IP mobility management—associated message to the multimode STA.

The following Table 14 shows exemplary information capable of being contained in the MIH_Network_Address_Information.request primitive, such that the exemplary information is transmitted to a destination.

TABLE 14
Local or Remote: Both, MIHF (Terminal) <-> MIHF (Network) <-> MIHF
(Network)

| Name | Type | Valid Range | Description |
|---|---|---|---|
| Source | Identifier | Any valid | The identifier of entity |
| Identifier | | individual or | where the request is |
| | | group | initiated. This field may be |
| | | identifier | optionally left empty if the |
| | | | command is local. |
| Destination | Identifier | MIH_LOCAL, | The destination identifier of |
| Identifier | | MIH_REMOTE | request or response. This is |
| | | | the identifier of local or |
| | | | peer MIH Function. |
| Current Link | Network Identifier. | Identifier | This identifies the current |
| Identifier | May be one of | | access net work over which |
| | different 802 and | | the command needs to be sent. |
| | Cellular networks. | | This is valid only for remote |
| | | | commands which need to be |
| | | | sent to remote MIHF. The |
| | | | command is then sent either |
| | | | at L2 or at L3. |
| MacMobileNode | MAC Address | N/A | MAC Address of Mobile Node |
| Current IP | Bitmap | 0~31 | Bit 0: IPv4 static |
| Configuration | | | configuration |
| Method | | | Bit 1: IPv4 dynamic |
| | | | configuration (DHCPv4) |
| | | | Bit 2: Mobile IPv4 with FA |
| | | | (FA-CoA) |
| | | | Bit 3: Mobile IPv4 without FA |
| | | | (Co-located CoA) |
| | | | Bits 4-10: reserved for |
| | | | IPv4 address configurations |
| | | | Bit 11: IPv6 stateless |
| | | | address configuration |
| | | | Bit 12: IPv6 stateful address |
| | | | configuration (DHCPv6) |
| | | | Bit 13: IPv6 manual |
| | | | configuration |
| | | | Bits 14-31: Reserved. |
| Current DHCP | IP Address | N/A | IP address of currnet DHCP |
| Server | | | Server. |
| Address | | | This parameter is only |
| | | | included when mobile node is |
| | | | using dynamic address |
| | | | configuration. |
| Current FA | IP Address | N/A | IP address of Current Foreign |
| Address | | | Agent. |
| | | | This parameter is only |
| | | | included when mobile node is |
| | | | using Mobile IPv4, |
| Current | IP Address | N/A | IP address of Current Access |
| Access Router | | | Router |
| Address | | | This parameter is only |
| | | | included when mobile node is |
| | | | using IPv6 |

As can be seen from Table 14, from the viewpoint of semantics, the multimode STA may transmit all or part of the combination of the Source Identifier parameter, the Destination Identifier parameter, the Current Link Identifier parameter, the Mac Mobile Node parameter, the Current IP Configuration Method parameter, the Current DHCP Server Address parameter, the Current Access Router Address parameter, the Current FA Address parameter, etc. to a destination using the MIH_Network_Address_Information.request primitive.

Detailed operations of the above-mentioned individual parameters are shown in Table 14.

2) When Generated:

According to the generation times of the above-mentioned primitives, if the handover initiation of the multimode STA is triggered by the link layer, the multimode STA generates/transmits the above-mentioned primitive, such that it initiates the network address (IP address) acquisition procedure.

3) Effect on Receipt:

Upon receiving the above-mentioned primitive, the new PoS or PoA may acquire a large amount of information by communicating with the upper layer. Also, the new PoS or PoA may transmit the received primitive to a specific entity including the network address information requested by the multimode STA in the network. The access router or foreign agent including the MIH function may be used as the specific entity. If the message is transmitted to the specific entity (e.g., the access router or the foreign agent) including the network's MIH function, this message may be triggered so that the above-mentioned entity can directly transmit the network address information to the multimode STA. The network address information may be an agent advertisement message in the case of the mobile IPv4, or may be a router advertisement message in the case of the agent advertisement message.

2. MIH_Network_Address_Information.indication

1) Function:

The MIH_Network_Address_Information.indication primitive indicates that a reception end has received the MIH_Network_Address_Information.Request message, and its own transmission contents are equal to those of the MIH_Network_Address_Information.request primitive.

3. MIH_Network_Address_Information.response

1) Function:

The MIH_Network_Address_Information.response primitive allows the correspondent MIH function entity to communicate with a transmission end which has transmitted the MIH_Network_Address_Information.request primitive This MIH_Network_Address_Information.response primitive transmits data regarding pre-configuration of the IP address to serving PoS or PoA, and serving PoS or PoA transmits it to the MN.

The following Table 15 shows exemplary information contained in the MIH_Network_Address_Information.response primitive.

TABLE 15
Local or Remote: Both, MIHF (Network) <-> MIHF (Network) <-> MIHF
(Terminal)

| Name | Type | Valid Range | Description |
|---|---|---|---|
| Source | Identifier | Any valid | The identifier of entity |
| Identifier | | individual or | where the request is |
| | | group | initiated. This field may |
| | | identifier | be optionally left empty |
| | | | if the command is local. |
| Destination | Identifier | MIH_LOCAL, | The destination |
| Identifier | | MIH_REMOTE | identifier of request or |
| | | | response. This is the |
| | | | identifier of local or |
| | | | peer MIH Function. |
| CurrentLinkIdentifier | Network | Identifier | This identifies the |
| | Identifier. | | current access net work |
| | May be one | | over which the command |
| | of | | needs to be sent. This is |
| | different | | valid only for remote |
| | 802 and | | commands which need to be |
| | Cellular | | sent to remote MIHF. The |
| | networks. | | command is then sent |
| | | | either at L2 or at L3. |
| MacMobileNode | MAC Address | N/A | MAC Address of Mobile |
| | | | Node |
| IP | Bitmap | 0~31 | Bit 0: IPv4 static |
| Configuration | | | configuration |
| Method | | | Bit 1: IPv4 dynamic |
| | | | configuration (DHCPv4) |
| | | | Bit 2: Mobile IPv4 with FA (FA- |
| | | | CoA) |
| | | | Bit 3: Mobile IPv4 without FA |
| | | | (Co-located CoA) |
| | | | Bits 4-10: reserved for IPv4 |
| | | | address configurations |
| | | | Bit 11: IPv6 stateless address |
| | | | configuration |
| | | | Bit 12: IPv6 stateful address |
| | | | configuration (DHCPv6) |
| | | | Bit 13: IPv6 manual |
| | | | configuration |
| | | | Bits 14-31: Reserved. |
| DHCP Server | IP Address | N/A | IP address of DHCP Server. |
| Address | | | This parameter is only |
| | | | included when mobile node |
| | | | is using dynamic address |
| | | | configuration |
| FA Address | IP Address | N/A | IP address of Foreign Agent. |
| | | | This parameter is only |
| | | | included when mobile node |
| | | | is using Mobile IPv4, |
| Access Router | IP Address | N/A | IP address of Access Router |
| Address | | | This parameter is only |
| | | | included when mobile node |
| | | | is using IPv6 |
| Result Code | Bitmap | 0~8 | Bit 0: IP configuration Method |
| | | | is not available |
| | | | Bit 1: DHCP Server address is |
| | | | not available |
| | | | Bit 2: FA Address is not |
| | | | available |
| | | | Bit 3: Access Router Address is |
| | | | not available |
| | | | Bit 4: No information is |
| | | | provided due to accessibility |
| | | | of same entity (FA, Access |
| | | | Router, DHCP Server, etc) |
| | | | Bit 5~7: Reserved |

As can be seen from Table 15, from the viewpoint of semantics, the multimode STA may transmit all or part of the combination of the Source Identifier parameter, the Destination Identifier parameter, the Current Link Identifier parameter, the Mac Mobile Node parameter, the IP Configuration Method parameter, the DHCP Server Address parameter, the FA address parameter, the Access Router Address parameter, and the Result Code parameter, etc. to a destination using the MIH_Network_Address_Information.response primitive.

2) When Generated:

The MIH_Network_Address_Information.response primitive is created by replying to the MIH_Network_Address_Information.request primitive received from the peer MIH function entity.

3) Effect on Receipt:

If the old PoS or PoA receives the MIH_Network_Address_Information.response primitive from the new PoS or PoA, it transmits the MIH_Network_Address_Information.response primitive to the multimode STA. If the new PoS or PoA directly receives the MIH_Network_Address_Information.request primitive from the multimode STA, it transmits a response message to the multimode STA.

4. MIH_Network_Address_Information.confirm

1) Function:

The MIH_Network_Address_Information.confirm primitive indicates that a reception end has received the MIH_Network_Address_Information.Response message, and its own transmission contents are equal to those of the MIH_Network_Address_Information.response primitive.

A method for implementing the command service by transmission/reception of the network address information message according to another preferred embodiment of the present invention will hereinafter be described by referring to the MIH_Network_Address_Information message communicated at a remote site.

1. MIH_Network_Address_Information.request

The MIH_Network_Address_Information.request primitive is indicative of a message which is transmitted from a single MIH function entity to another MIH function entity at a remote site. This MIH_Network_Address_Information.request message is transmitted to acquire network address—associated information before the handover of the multimode STA.

Upon receiving the MIH_Network_Address_Information.request message, the remote MIH function entity may acquire requested information by interacting with its own upper entity, may connect the MIH_Network_Address_Information.request message to a network entity including a sufficient amount of the requested information, and may transmit the MIH_Network_Address_Information.request message to the network entity.

The Serving FA Address parameter, the Serving Access Router Address parameter, and the DHCP Server Address parameter are differently determined according to the IP Address Configuration Method parameter. For example, if the IP Address Configuration Method parameter is set to the IPv4 dynamic configuration (DHCPv4), the IP address contained in the Serving FA Address, Serving Access Router Address, and DHCP Server Address parameters may be set to the DHCP Server Address (IPv4).

The following Table 16 shows exemplary formats of the MIH_Network_Address_Information.request message.

TABLE 16

| Name | Type |
|---|---|
| MacMobileNode | Mobile Node MAC |
| | Address (251) |
| IPConfigurationMethods | IP Address |
| | Configuration Methods |
| | List (2) |
| Serving FA Address/ | IP Address (247) |
| Serving Access | |
| Router Address/ | |
| DHCP Server Address | |

2. MIH_Network_Address_Information Response

The MIH_Network_Address_Information Response message is indicative of a response message to the MIH_Network_Address_Information Request message.

The Serving FA Address parameter, the Serving Access Router Address parameter, and the DHCP Server Address parameter are contained in the MIH_Network_Address_Information Response message, and are differently determined according to the IP Address Configuration Method parameter.

For example, if the IP Address Configuration Method parameter is set to the IPv4 dynamic configuration (DHCPv4), the IP address contained in the Serving FA Address, the IP address contained in the Serving Access Router Address, and DHCP Server Address parameters may be set to the DHCP Server Address (IPv4).

If at least one IP address configuration method is supported, the above-mentioned operation is repeated as several times as the number of IP configuration methods established in the Serving FA/Serving Access Router Address/DHCP Server Address parameters, and corresponding IP address information is arranged in numerical order of IP Configuration Methods Bit.

The following Table 17 exemplarily shows the MIH_Network_Address_Information Response message format.

TABLE 17

| Name | Type |
|---|---|
| MacMobileNode | Mobile Node MAC Address |
| | (251) |
| IPConfigurationMethods | IP Address |
| | Configuration Methods |
| | List (2) |
| FA Address/Access | IP Address (247) |
| Router Address/DHCP | |
| Server Address | |
| IP Address Information | IP Address Information |
| Status | Status Code (26) |

The following Table 18 exemplarily shows the IP Configuration Methods parameter from among several parameters contained in the MIH_Network_Address_Information message acting as a protocol message communicated at a remote site.

TABLE 18

| Type | Length | Value |
|---|---|---|
| 2 | 1 | Indicates types of IP address Configuration method |
| | | supported by the new PoA. |
| | | 0: IPv4 static configuration |
| | | 1: IPv4 dynamic configuration (DHCPv4) |
| | | 2: Mobile IPv4 with FA (FA-CoA) |
| | | 3: Mobile IPv4 without FA (Co located CoA) |
| | | 4~10: Reserved for IPv4 address configuration |
| | | 11: IPv6 stateless address configuration |
| | | 12: Ipv6 stateful address configuration (DHCPv6) |
| | | 13: Ipv6 manual congifuration |
| | | 14~255: Reserved |

The following Table 19 exemplarily shows the IP Address Information Status parameter from among several parameters contained in the MIH_Network_Address_Information message acting as a protocol message communicated at a remote site.

TABLE 19

| Type | Length | Value |
|---|---|---|
| 26 | 1 | 0: IP configuration Method is not available |
| | | 1: DHCP Server address is not available |
| | | 2: FA Address is not available |
| | | 3: Access Router Address is not available |
| | | 4: No information is provided due to |
| | | accessibility of same entity (FA, Access Router, |
| | | DHCP Server, etc) |
| | | 5~255: Reserved |

If it is impossible to provide the IP address configuration information, or if the IP address information is not contained in corresponding values, the corresponding values may inform necessary objects of the reasons.

If the received information is equal to information received from the multimode STA such that the resources to be consumed must be reduced, only a specific indicator indicating the above-mentioned situation may be transmitted to necessary parts.

Next, a method for pre-configuration of IP address according to another embodiment of this invention will be described referring to the following parameters.

1. MIH_MN_HO_{—Candidate}_Query.Request

This primitive mainly corresponds to the above mentioned MIH_Network_Address_Information.request primitive. As like the MIH_Network_Address_Information.request primitive, this primitive is transmitted from the MIF function entity of the multimode MN to a current PoS (Point of Service) or PoA (Point of Attachment).

Specifically, MIH_MN_HO_Candidate_Query Request is for query if a current IP configuration method of ongoing data session can be supported in candidate networks. And, this primitive can comprise IP Configuration Methods IE as shown in the tables 10˜12.

2. MIH_{—N}2N_HO_Query_Resource.Request

This primitive mainly corresponds to the above mentioned MIH_Network_Address_Information.request primitive. But, it is different from the MIH_MN_HO_Candidate_Query Request because this primitive is transmitted by the serving PoA or PoS, not by the MN. Upon receiving the MIH_MN_HO_Candidate_Query Request primitive from the MN, the PoS or PoA transmits this MIH_N2N_HO_Query_Resource.Request primitive to one or more of the candidate networks.

As like the MIH_MN_HO_Candidate_Query Request primitive, this primitive can comprise IP Configuration Methods IE as shown in the tables 10˜12.

3. MIH_N2N_HO_Query_Resource.Response

This primitive mainly corresponds to the above mentioned MIH_Network_Address_Information.response primitive. As like the MIH_Network_Address_Information.response allows the correspondent MIH function entity to communicate with a transmission end which has transmitted the MIH_Network_Address_Information.request primitive (or, MIH_N2N_HO_Resources Request primitive)

As like the MIH_MN_HO_Candidate_Query Request primitive, this primitive can comprise IP Configuration Methods IE as shown in the tables 10˜12.

4. MIH_MN_HO_Candidate_Query Response

This primitive mainly corresponds to the above mentioned MIH_Network_Address_Information.response primitive. But, it is different from the MIH_N2N_HO_Query_Resource.Response because this primitive is received by the MN, not by the serving PoA or PoS. Upon receiving the MIH_N2N_HO_Query_Resource.Response primitive, the PoS or PoA transmits this MIH_MN_HO_Candidate_Query.Response primitive to the MN.

As like the MIH_MN_HO_Candidate_Query Request primitive, this primitive can comprise IP Configuration Methods IE as shown in the tables 10˜12.

Next, another method from among methods proposed by the present invention will hereinafter be described in detail. The method transmits an IP—associated information request message to the PoS or PoA of the network to which the multimode STA is to be handed over via the command service, receives the IP address configuration—associated information from the entity including the corresponding information, and performs pre-configuration of the IP address prior to the handover.

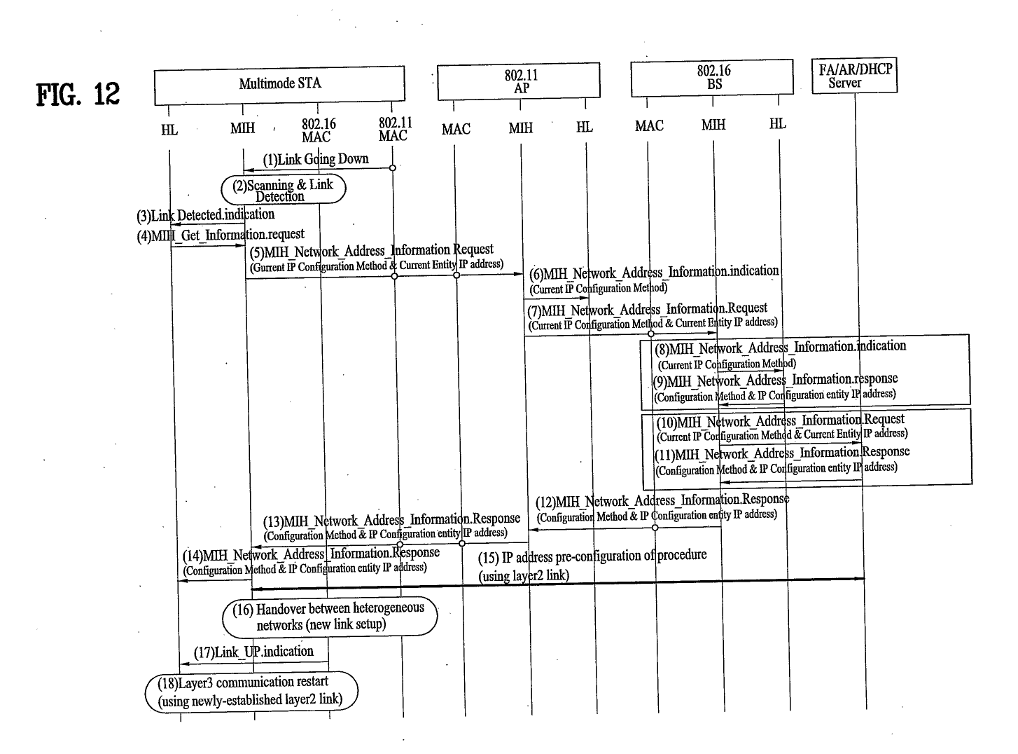

FIG. 12 is a flow chart illustrating a method for pre-configuration of an IP address in a mobile communication system according to another preferred embodiment of the present invention.

The multimode STA transmits the IP-associated information request message to the PoS or PoA of the network to which the multimode STA is to be handed over via the command service, and receives the IP address configuration—associated information from the entity including corresponding information, thereby pre-configuration of the IP address prior to the handover.

Referring to FIG. 12, the mobile node (MN) receives a specific message from a current access link layer. This specific message indicates that a current link is bad or the link connection will be released due to poor network situations at step (1).

If the mobile node (MN) is determined to be the multimode STA, the multimode STA detects another network to which the multimode STA is to be handed over by the scanning operation at step (2).

If the presence of the detected network is determined, the MN informs the upper management entity (HL) of the detected network at step (3).

The upper management entity (HL) establishes a method for configuration of an IP address to be used by a PoA or PoS to which the MN is to be handed over, and requests IP address information of an entity to be contacted from the MIH function entity, such that the IP address information is transmitted to the information server at step (4).

The MIH function entity transmits a remote message for requesting information according to a request of the upper management entity (HL) to the information server. The above-mentioned remote message may include not only information of a method for configuration of an IP address which is currently used by the MIH function itself and configuration method which is being used, but also information of an IP address of the contacted entity. As a result, if the reception end uses the same method and the same IP address configuration entity, the same information is not repeatedly transmitted at step (5).

The multimode STA informs the HL that the network address information acquisition request has been received at step (6). If required, this step (6) may not occur.

The MIH entity transmits the received information to the new PoS or PoA. In this case, the new PoA—associated information may be determined by referring to the MAC address of a specific PoS contained in the request message of the multimode STA. The transmission of the above-mentioned new message is not shown in FIG. 12 in the case of the determination of the HL. However, if the HL transmits the MIH_Network_Address_Information.request message to the MIH function entity, the above-mentioned new message transmission may occur at step (9).

At steps 8)˜9), if the new PoS or PoA includes corresponding information, it may acquire requested information by communicating with the HL.

At steps 10)˜11), if the new PoS or PoA does not include the corresponding information, it may transmit the corresponding information to a specific entity (e.g., Foreign agent, access router, DHCP server, or network management entity) including the corresponding information. In more detail, the processes 10)˜11) can be performed only when the corresponding information cannot be acquired by the process (8).

If required, the entity contained in the network may directly transmit the IP mobility management protocol messages (e.g., (unsolicited) DHCP reply message, agent advertisement message, and router advertisement message) to the multimode STA. Also, the above-mentioned messages may also be transmitted via the new PoS or PoA using the MIH_Network_Address_Information Response message including the above-mentioned requested information. In this way, if the above-mentioned requested information is transmitted via the MIH_Network_Address_Information Response message, the following steps 12) and 13) can be executed.

The acquired information is transmitted to the old PoS or PoA via the MIH_Network_Address_Information Response message at step (12).

The old PoS or PoA transmits the above-mentioned information to the multimode STA via the MIH_Network_Address_Information Response message at step (13).

The MIH function receives the above-mentioned information, and transmits the received information to the HL at step (14).

The multimode STA contacts the entity acquiring using the received information, and pre-establishes the IP address at step (15).

The multimode STA performs the handover procedure including the new link setup process at step (16).

In the case where f the new wireless link setup is completed by the completion of the handover, the HL receives information indicating the above-mentioned case at step (17).

Since the multimode STA pre-establishes the IP address before the handover, there is no need to establish an additional IP address after the handover, and the multimode STA transmits upper packets to the newly-established wireless link via the IP link.

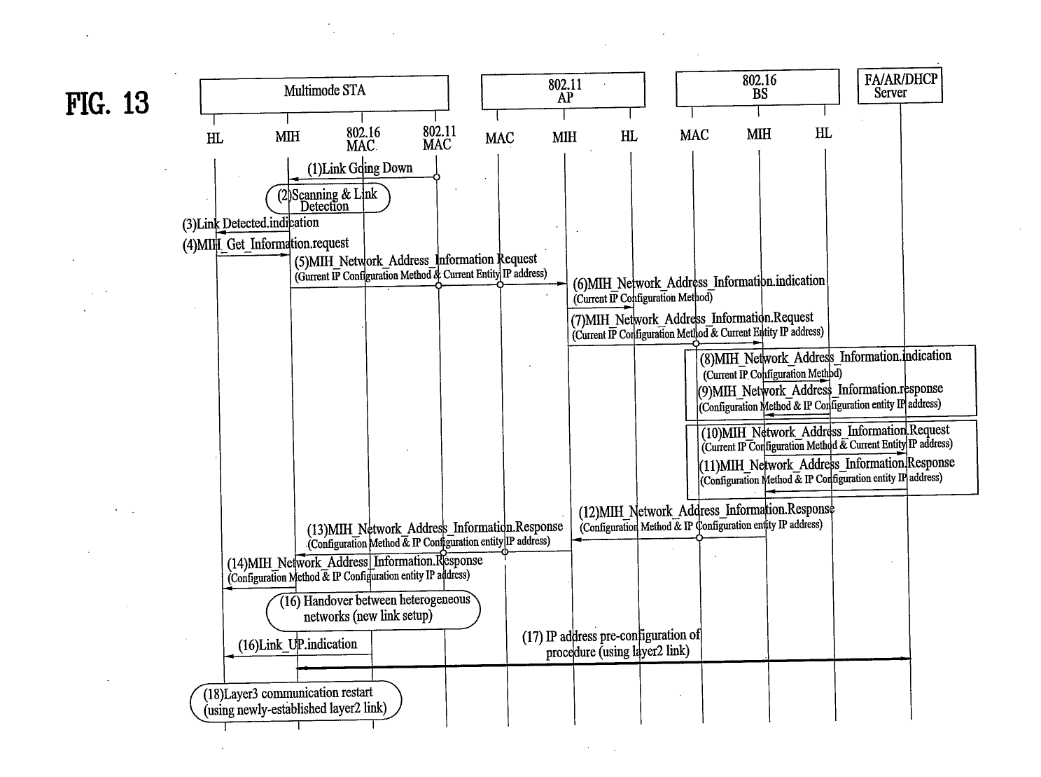

FIG. 13 is a flow chart illustrating a method for pre-configuration of an IP address in a mobile communication system according to a fifth preferred embodiment of the present invention.

Prior to describing operations of FIG. 13, it should be noted that the processes 1)˜14) are equal to those of FIG. 12, such that their detailed description will herein be omitted for the convenience of description.

Referring to FIG. 13, according to the IP address configuration procedure, the multimode STA connects a link to a target access point (AP), receives the link setup completion message via the Link_Up.indication message, and connects a new link (i.e., a layer2 link) to the target AP, such that the IP address configuration procedure can be performed as shown in the following process 15)˜18).

The multimode STA performs a handover procedure including a new-link setup process at step (15).

In the case where the new wireless link setup is terminated by the completion of the handover, the HL receives information indicating the above case at step (16).

The multimode STA contacts the entity acquired by the response information, and pre-establishes the IP address. Preferably, the IP address may be pre-established by the new link (i.e., Layer2 link) established by the process 8 at step (17).

Since the multimode STA pre-establishes the IP address before the handover, there is no need to establish an additional IP address after the handover, and the multimode STA may transmit upper packets to the newly-established wireless link via the IP link at step (18).

According to another preferred embodiment of present invention, the multimode STA may acquire IP address configuration—associated information from the information server while it connects a link to a target AP. In this case, the MIH protocol message for acquiring the IP address configuration information may be encapsulated in a corresponding layer2 management frame or a layer2 management message, such that the encapsulated resultant message may be transmitted to a destination. After acquiring the IP address configuration—associated information, the link connection to the target AP is completed, the Link_Up.indication message indicates the completion of the link setup process, and then the IP address configuration procedure may be executed.

According to the above-mentioned preferred embodiments of the present invention, different entities for commanding the IP address configuration are generated according to the IP address configuration methods acquired from the IP address configuration—associated information.

For example, a currently-used IP address configuration method assumes the mobile IPv4 based on the foreign agent. And, it is assumed that an IP address configuration method to be used at a target AP is a DHCP version 4. In this case, if the layer2 link setup procedure associated with a new AP is completed, the DHCP version4-entity contained in the multimode STA receives an IP address configuration command, thereby performing the IP address configuration process.

It should be noted that most terminology disclosed in the present invention is defined in consideration of functions of the present invention, and can be differently determined according to intention of those skilled in the art or usual practices. Therefore, it is preferable that the above-mentioned terminology be understood on the basis of all contents disclosed in the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

As apparent from the above description, if there arises a handover caused by the IP address change in a wireless communication system, the present invention can receive IP address configuration—associated information prior to the handover. Also, the present invention pre-establishes the IP address, which can be used after the handover, before the handover using the above-mentioned method, such that a time delay required for the IP configuration process after the handover can be shortened.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for pre-configuration of IP (Internet Protocol) address by a mobile node (MN), the method comprising:
transmitting a request message for the pre-configuration of IP address; and
receiving a response message to the request message, the response message comprises information indicating which IP configuration method in IP configuration methods information is supported at one or more point of attachment (PoA).

2. The method according to claim 1, further comprising:
performing the pre-configuration of the IP address based on the received response message.

3. The method according to claim 1, wherein if the information indicating which IP configuration method is supported indicates supporting of IPv4 dynamic configuration (DHCPv4), mobile IPv4 without foreign agent (Co-located CoA) or IPv6 stateful address configuration (DHCPv6), the response message further comprises dynamic host configuration protocol (DHCP) server address type-length value (TLV).

4. The method according to claim 1, wherein if the information indicating which IP configuration method is supported indicates supporting of mobile IPv4 with foreign agent (FA-CoA) or IPv6 stateless address configuration, the response message further comprises foreign agent or access router (FA/AR) address type-length value (TLV).

5. A method for pre-configuration of IP (internet Protocol) address by a mobile node (MN), the method comprising:
transmitting to a serving point of service (PoS) a request message for query if a current IP configuration method of ongoing data session can be supported in one or more candidate networks; and
receiving a response message to the request message, the response message comprises information for IP address of the one or more candidate networks and IP configuration methods for each of the candidate networks.

6. The method according to claim 5; further comprising:
performing the pre-configuration of the IP address of a target network based on the information from the received message, the target network is decided based on the information from the received message.

7. The method according to claim 5, wherein the request message comprises information for the current IP configuration method of the ongoing data session and a current link IP address.

8. The method according to claim 7, wherein the information for the current IP configuration method is information indicating which IP configuration method in IP configuration methods information is supported.

9. The method according to claim 8, wherein if the information for the current IP configuration method indicates supporting of IPv4 dynamic configuration (DHCPv4), mobile IPv4 without foreign agent (Co-located CoA) or IPv6 stateful address configuration (DHCPv6), one or more of the request message and the response message to the request message further comprise dynamic host configuration protocol (DHCP) server address type-length value (TLV).

10. The method according to claim 8, wherein if the information for the current IP configuration method indicates supporting of mobile IPv4 with foreign agent (FA-CoA) or IPv6 stateless address configuration, one or more of the request message and the response message to the request message further comprise foreign agent or access router (FA/AR) address type-length value (TLV).

11. A method for relaying messages for pre-configuration of IP (internet Protocol) address by a serving point of service (PoS), the method comprising:
receiving from mobile node (MN) a first request message query if a current IP configuration method of ongoing data session can be supported in one or more candidate networks;
transmitting to media independent handover function (MIHF) of the candidate networks a second request message comprising information for the current IP configuration method;
receiving from the one or more candidate networks a first response message comprising information for IP addresses of the candidate networks and IP configuration methods for each of the candidate networks; and
transmitting to the MN a second response message to the first request message comprising information regarding the first response message.

12. The method according to claim 11, wherein the first request message comprises information for the current IP configuration method of the ongoing data session and a current link IP address.

13. The method according to claim 12, wherein the information for the current IP configuration method is information indicating which IP configuration method in IP configuration methods information is supported.

14. The method according to claim 13, wherein if the information for the current IP configuration method indicates supporting of IPv4 dynamic configuration (DHCPv4), mobile IPv4 without foreign agent (Co-located CoA) or IPv6 stateful address configuration (DHCPv6), one or more of the first request message, the second request message, the first response message and the second response message further comprise dynamic host configuration protocol (DHCP) server address type-length value (TLV).

15. The method according to claim 13, wherein if the information for the current IP configuration method indicates supporting of mobile IPv4 with foreign agent (FA-CoA) or IPv6 stateless address configuration, one or more of the first request message, the second request message, the first response message and the second response message further comprise foreign agent or access router (FA/AR) address type-length value (TLV).

16. A method for performing media independent handover (MIH) based on a pre-configuration of IP (internet Protocol) address by a mobile node (MN), the method comprising:
transmitting to a serving point of service (PoS) a first request message for query if a current IP configuration method of ongoing data session can be supported in one or more candidate networks;
receiving a first response message to the first request message, the first response message comprises information for IP address of the one or more candidate networks and IP configuration methods for each of the candidate networks; and
transmitting to the serving PoS a second request message for informing the serving PoS to commit handover to a target network, the target network is decided based on the information from the received message.

17. The method according to claim 16, further comprising:
receiving a second response message to the second request message for indicating the MN of status of operation of performing handover to the target network.

18. The method according to claim 16 or 17, wherein the first request message comprises information for the current IP configuration method of the ongoing data session and a current link IP address.

19. The method according to claim 18, wherein the information for the current IP configuration method is information indicating which IP configuration method in IP configuration methods information is supported.

20. The method according to claim 19, wherein if the information for the current IP configuration method indicates supporting of IPv4 dynamic configuration (DHCPv4), mobile IPv4 without foreign agent (Co-located CoA) or IPv6 stateful address configuration (DHCPv6), one or more of the first request message and the first response message further comprise dynamic host configuration protocol (DHCP) server address type-length value (TLV).

21. The method according to claim 19, wherein if the information for the current IP configuration method indicates supporting of mobile IPv4 with foreign agent (FA-CoA) or IPv6 stateless address configuration, one or more of the first request message and the first response message further comprise foreign agent or access router (FA/AR) address type-length value (TLV).

22. A method for relaying messages for performing media independent handover (MIH) based on pre-configuration of IP (internet Protocol) address by a serving point of service (PoS), the method comprising:
receiving from mobile node (MN) a first request message query if a current IP configuration method of ongoing data session can be supported in one or more candidate networks;
transmitting to media independent handover function (MIHF) of the candidate networks a second request message comprising information for the current IP configuration method;
receiving from the one or more candidate networks a first response message comprising information for IP addresses of the candidate networks and IP configuration methods for each of the candidate networks;
transmitting to the MN a second response message to the first request message comprising information regarding the first response message;
receiving from the MN a third request message for informing the serving PoS to commit handover to a target network, the target network is decided by the MN based on the information from the second response message; and
transmitting to the target network a third response message for indicating the target network of a fact that the MN is about to move to the target network.

23. The method according to claim 22, wherein the first request message comprises information for the current IP configuration method of the ongoing data session and a current link IP address.

24. The method according to claim 23, wherein the information for the current IP configuration method is information indicating which IP configuration method in IP configuration methods information is supported.

25. The method according to claim 24, wherein if the information for the current IP configuration method indicates supporting of IPv4 dynamic configuration (DHCPv4), mobile IPv4 without foreign agent (Co-located CoA) or IPv6 stateful address configuration (DHCPv6), one or more of the first request message, the second request message, the first response message and the second response message further comprise dynamic host configuration protocol (DHCP) server address type-length value (TLV).

26. The method according to claim 24, wherein if the information for the current IP configuration method indicates supporting of mobile IPv4 with foreign agent (FA-CoA) or IPv6 stateless address configuration, one or more of the first request message, the second request message, the first response message and the second response message further comprise foreign agent or access router (FA/AR) address type-length value (TLV).
